(19) United States
(12) Patent Application Publication
(10) Pub. No.: US 2026/0028192 A1
(43) Pub. Date: Jan. 29, 2026

(54) LINEAR DRIVE CONVEYOR

(71) Applicant: Dematic Corp., Grand Rapids, MI (US)

(72) Inventors: Daniel J. Nowicki, Belmont, MI (US); James R. VanOeffelen, Holland, MI (US)

(21) Appl. No.: 19/099,232

(22) PCT Filed: Aug. 1, 2023
(86) PCT No.: PCT/IB2023/057810

§ 371 Date: Jan. 28, 2025

Related U.S. Application Data
(60) Provisional application No. 63/394,153, filed on Aug. 1, 2022.

(51) Int. Cl. B65G 54/02

(52) U.S. Cl. CPC B65G 54/02; B65G 2203/025; B65G 2203/0283; B65G 2203/046

(57) ABSTRACT

A conveyor system for transporting goods within a warehouse facility. The system includes an array of guide tracks and carriages moveable along the guide tracks for transporting goods within the warehouse facility. A drive system includes drivers spaced along the guide tracks. The drivers may utilize linear induction motors, propels the carriages along the guide tracks. The linear induction motors utilize stepper motors, and optionally microstepping motors. A warehouse management system controls the linear drive system to transport goods throughout warehouse facility for storage and order fulfilment. The linear driver conveyor system includes perpendicular transfers at which carriages can be transferred from one conveyor line to another, without the need for mechanical processes, such as lift or buffers, to move the carriage between conveyor lines.

### CROSS REFERENCE TO RELATED APPLICATION

The present application claims priority of U.S. provisional application Ser. No. 63/394,153 filed Aug. 1, 2022, which is hereby incorporated herein in its entirety.

### FIELD OF THE INVENTION

The present invention is directed to a conveyor system, and in particular a material handling conveyor system.

### BACKGROUND OF THE INVENTION

Roller conveyors and belt conveyors as commonly known in the art include many moving or dynamic components, including electric motors, rollers, bearings, belts, lifts, complex support infrastructure for accessory items such as photoeyes, cable management, and scanners. Roller conveyors commonly require maintenance, calibration, and adjustment, including roller changes, motor changes, roller pitch adjustment, and compensation for proper sensing and tracking of the products being moved. Special considerations often need to be made based on a user's product profile.

Conveyor line transfer segments, commonly referred to as right-angle transfers (RATs), require a lifting component to either transfer an item from one conveyor line to another, or to raise and lower one or two transport surfaces relative to one another. The lifting component may be electrical or pneumatic. Commonly available RATs involve or require complex mechanical design that requires height adjustment or calibration to properly convey articles at angles. RATs typically include a high number of moving parts, and service of the RAT module can be complex.

Standard conveyor systems include three basic components, straights, curves, and transfers, which are each unique to a particular user's requirements. The variations of all these components often necessitates that development, installation, and commissioning time are high as each unique instance requires some type of mechanical and programming change.

### SUMMARY

Accordingly, a linear drive conveyor system for transporting goods within a warehouse facility includes a plurality of guide tracks disposed in the warehouse facility, a carriage supported on and moveable along the guide tracks and configured to support goods for transport within the warehouse facility, a drive system for propelling the carriage along the guide tracks, and optionally a warehouse management system adapted for controlling the drive system to transport goods on the carriage within the warehouse facility. The drive system comprises a driver coupled at a portion of the guide track and is configured to remotely push and/or pull the carriage without contacting the carriage to propel the carriage along the guide tracks relative to the driver.

In one aspect, the carriage comprises a plurality of roller supports configured to support the carriage at a support surface of the guide tracks. For example, the roller supports may comprise a ball transfer bearing.

In another aspect, each of the guide tracks comprises a pair of spaced apart side rails. Each of the side rails includes a channel formed therein and is configured to receive a portion of one of the roller supports to at least partially retain the roller support in a desired position along the side rail.

In any of the above, the carriage comprises a magnetic array, and the driver comprises a linear induction motor system having a drive coil coupled to the guide track and configured to magnetically push and/or pull the magnetic array of the carriage in order to propel the carriage along the guide tracks.

For example, the linear induction motor comprises a 2-phase stepper motor or a 3-phase motor.

In any of the above, the conveyor system further includes a warehouse management system in communication with the driver. Further, in any of the above, the conveyor system may include a carriage presence sensor coupled at least one of the guide tracks and the carriage, which is configured to communicate a location of the carriage relative to the driver to the warehouse management system. For example, the presence sensor may be selected from a group consisting of Hall effect sensor, magnetic proximity sensor, MEMS sensor, optical sensor, mechanical sensor, and integrated sensor.

In any the above, the conveyor system further includes a plurality of the drivers disposed along the guide tracks and a plurality of the carriage presence sensors, wherein at least one of the plurality of the carriage sensors is provided proximate each one of the drivers.

For example, a pair of the carriage presence sensors may be provided at each of the drivers, wherein a first one of the pair of carriage presence sensors is provided at an upstream side of a particular one of the drivers to detect entry of the carriage into proximity with the particular driver and a second one of the pair of carriage presence sensors is provided at a downstream side of the particular driver to detect exit of the carriage from proximity with the particular driver.

In any of the above, the array of guide tracks comprise one or more intersections of guide tracks, with the intersections forming a transfer location for carriages to transfer from one of the guide tracks to another of the guide tracks.

In any of the above, the conveyor system further includes an RFID reader system disposed throughout the warehouse facility and in communication with the warehouse control system, and an RFID tag coupled to the carriage, wherein the warehouse control system is operable to track a position the carriage relative to the driver as a function of the RFID reader system reading the RFID tag of the carriage.

According to yet another aspect, a method of controlling a transport carriage in a warehouse facility includes providing a linear driver conveyor system having an array of guide tracks configured to support and guide a transport carriage as it moves throughout the warehouse facility, wherein the carriage is propelled by a linear drive system having a series of drivers disposed along the guide track, the drivers controlled by a warehouse management system, determining, with the warehouse management system, that the carriage is to be transported from one location in the warehouse facility to a required location, activating, with the warehouse management system, a first one of the series of drivers that is proximate the carriage to push or pull the carriage along the guide track in the direction of the required location, and activating a second one of the series of drivers downstream of the first driver to continue pushing or pulling the carriage along the guide track in the direction of the required location.

In one aspect, the method further includes deactivating the first driver before activating the second driver.

In either method above, the method can further include determining a location of the carriage relative to the first driver with a carriage position sensor and activating the second driver to continue pushing or pulling the carriage once it has exited the influence of the first driver.

In a further aspect, the determining the location of the carriage relative to the first driver comprises detecting the entry of the carriage into proximity with the first driver with a first carriage presence sensor at an upstream side of the driver and/or detecting the exit of the carriage from proximity with the first driver with a second carriage presence sensor at a downstream side of the driver.

In any method above, each of the series of drivers comprises a 2-phase stepper motor and the activating of any of the series of drivers comprises microstepping the stepper motor.

For example, the microstepping comprises driving the stepper motor at less than one full drive step. Optionally, the microstepping comprises driving the stepper motor at at least one chosen from ½ of a drive step, ¼ of a drive step, ⅛ of a drive step, 1/16 of a drive step, 1/32 of a drive step, 1/64 of a drive step, 1/128th of a drive step, and 1/256th of a drive step.

In any the methods above, the linear drive conveyor comprises a plurality of the carriages, with the method further including determining a presently required capacity of carriages within the warehouse facility with the warehouse management system, and either chosen from introducing additional carriages into the linear driver conveyor system and removing carriages from the linear drive conveyor system to meet the presently required capacity.

In yet another aspect, a linear drive conveyor system adapted to control processing operations includes a trunk network, a SYNC network for coordination of motion between a first driver and a second driver, a trigger configured to address and sync one or more interrupts of the truck network, and wherein the SYNC network causes one of the first driver or the second driver to communicate a present state of the first or second driver.

### BRIEF DESCRIPTION OF THE DRAWINGS

FIG. 1 is a top perspective view of a linear drive conveyor grid system, in accordance with the present invention;

FIG. 2 is a top perspective view of a guide track of the linear drive conveyor system of FIG. 1;

FIG. 3 is top perspective view of a transport carriage of the linear drive conveyor system of FIG. 1;

FIG. 4 is bottom perspective view of the carriage of FIG. 3;

FIG. 5 is bottom perspective view of a carriage of the linear drive conveyor system, depicted with the guide track omitted to show detail of the underside of the carriage;

FIG. 6 is a top perspective view of a set of linear drive motors of the linear drive conveyor system of FIG. 1;

FIG. 7A is a plan view of a circular magnetic drive motor;

FIG. 7B is a plan view of a linear magnetic drive motor;

FIG. 8 is a top perspective view of a linear drive motor of the linear drive system of FIG. 1, depicted with a guide track, carriage, and carriage magnet array shown in phantom to show detail of a linear driver;

FIG. 9 is a top perspective view of the guide track and linear driver of FIG. 8;

FIGS. 10A-10B are side perspective views of the system of FIG. 1, depicting sequential movement of a carriage along guide tracks of the linear drive conveyor;

FIG. 11 is a top perspective view of a right angle transfer segment of the linear drive conveyor of FIG. 1;

FIGS. 12A-12D are top perspective views of the system of FIG. 1, depicting sequential movement transfer of a carriage between conveyor lines at a right angle transfer;

FIG. 13 is another top perspective view of the linear drive motor of the linear drive system of FIG. 9, depicted with the guide track, carriage, and carriage magnet array shown in phantom to show detail of a linear driver;

FIG. 14 is a top perspective view of an injection/removal point for a linear drive conveyor system, in accordance with the present invention;

FIG. 15 is a top perspective view of a carriage with side walls, for use in a linear drive conveyor;

FIG. 16 is an exemplary control diagram of for controlling a linear drive conveyor system, in accordance with the present invention;

FIG. 17 is a top perspective view of an automated storage and retrieval array or high density storage facility formed of linear drive conveyors, in accordance with the present invention;

FIG. 18 is a top perspective view of an inbounding, receiving, and shipping array formed of linear drive conveyors, in accordance with the present invention;

FIG. 19 is a top perspective view of an automated palletizing array formed of linear drive conveyors, in accordance with the present invention;

FIG. 20 is a top perspective view of a robotic picking cell and a linear drive conveyor system, in accordance with the present invention;

FIG. 21 is a top perspective view of a routing and buffering system formed of linear drive conveyors, in accordance with the present invention;

FIG. 22 is a bottom perspective view of the routing and buffering system of FIG. 21;

FIG. 23 is a sectional top perspective view of a linear induction drive motor of the linear drive conveyor of FIG. 1.

FIG. 24 is a sectional bottom perspective view of the linear induction drive motor of FIG. 23;

FIGS. 25-29B are various sectional views of the linear induction drive motor of FIG. 23, depicting various states of operation of the drive motor;

FIG. 30 is a top perspective view of a carriage of the linear drive conveyor system of FIG. 1 with magnetic arrays having bar shaped magnetic elements;

FIG. 31 is a bottom perspective view of the carriage of FIG. 30;

FIG. 32 is a bottom perspective view of a guide tray or frame for supporting a carriage of a linear drive conveyor system;

FIG. 33 is another bottom perspective view of the guide tray of FIG. 32, depicted with covers of linear drive motors omitted to show internal structure of the drive motors;

FIG. 34 is a bottom perspective view of another carriage of a linear drive conveyor system, in accordance with an aspect of the present invention, the carriage having a t-shaped magnetic array;

FIG. 35 is a top perspective view of the carriage of FIG. 34;

FIG. 36 is a bottom perspective view of a guide tray or frame for supporting a carriage of a linear drive conveyor system, in accordance with the present invention, the tray having a centrally located linear drive motor;

FIG. 37 is a top perspective view of the guide tray of FIG. 36, depicted with an upper cover of the linear drive motor omitted to show internal structure of the drive motor;

FIG. 38 a top perspective view of an active carriage and a smart carriage bay for a linear drive conveyor system, in accordance with an aspect of the present invention;

FIG. 39 is a bottom perspective view of the carriage of FIG. 30 with another arrangement of magnetic arrays;

FIG. 40 is a top perspective view of a guide tray or frame with another arrangement of linear induction motors;

FIG. 41 is a top perspective view of a guide tray or frame with another arrangement of linear induction motors;

FIG. 42 is enlarged perspective view of a linear induction motor with a wireless device, such as an RFID reader;

FIG. 43 is a bottom perspective view of the carriage of FIG. 30 with another arrangement of magnetic arrays and a wireless device, such as an RFID tag;

FIG. 43A is a bottom perspective view of the carriage of FIG. 30 with another arrangement of a wireless device, such as an RFID tag;

FIG. 44 is an enlarged fragmentary perspective of a carriage with a wireless device, such as an RFID tag:

FIG. 45 is a perspective view of a tray guide or frame with wireless devices, such as an RFID reader, adjacent the linear induction motors;

FIG. 46 is enlarged perspective view of a three phase linear induction driver or motor with a wireless device, such as an RFID reader;

FIG. 46A is a cross-section of the driver of FIG. 46;

FIG. 46B is a similar view to FIG. 46A showing a first stage of 3 phase commutation;

FIG. 46C is a similar view to FIG. 46B showing a second stage of 3 phase commutation; and

FIG. 46D is a similar view to FIG. 46C showing the third stage of 3 phase commutation.

### DESCRIPTION OF THE PREFERRED EMBODIMENTS

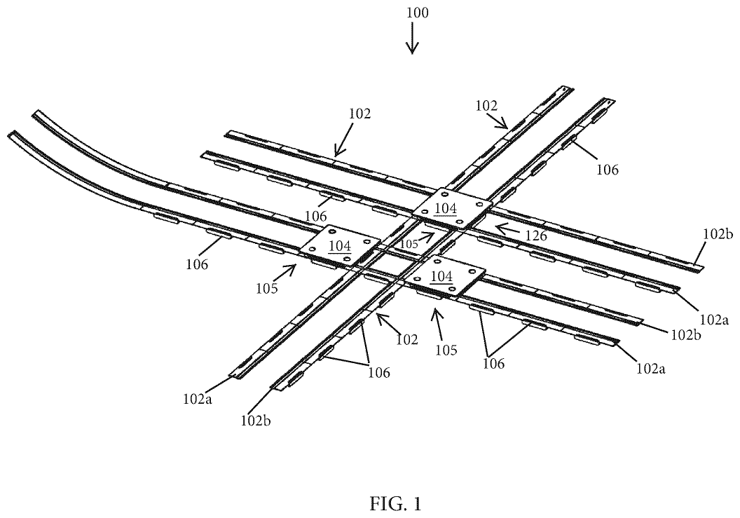

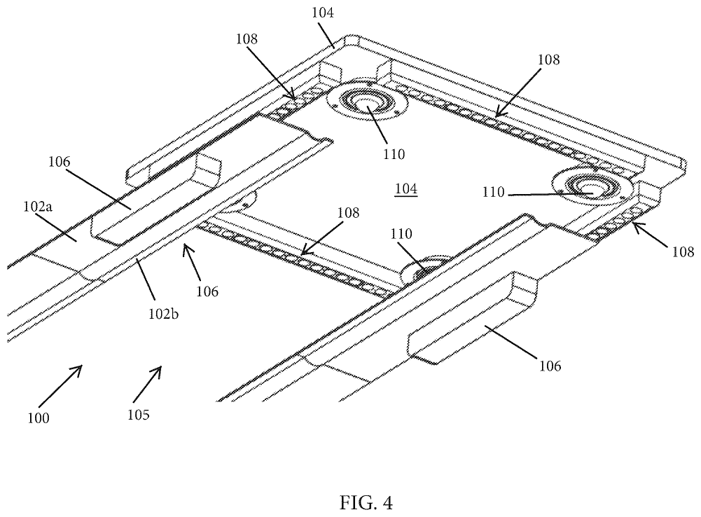

Referring now to the drawings and the illustrative embodiments depicted therein, an article conveyor system having minimal moving parts is provided for the transport of goods within a warehouse facility. The conveyor system is formed of a linear drive conveyor system 100 having an array of guide tracks 102 that are spaced throughout a warehouse facility and carriages 104 that are supported at and moveable along the guide tracks 102 (FIG. 1). The carriages 104 are supported at the guide tracks 102 with minimal moving parts. In other words, the carriages 104 and guide tracks 102 interact with one another with few to no moving parts there between, providing for a cost effective, low-maintenance and efficient conveyor system for the transport of items, cases, goods, articles, etc. through the warehouse. The carriages 104 are driven (e.g. pushed and pulled) along the guide tracks 102 with a linear drive motor or system 105 having a series or array of linear drivers 106, in the form of linear induction motors, for example (FIG. 4). The array of guide tracks 102 may include intersections between two or more guide track sections, in which the intersections provide a transfer location 126 where a carriage 104 may move or transfer from one guide track path to another guide track path. The linear drivers 106 may utilize stepper motors, enabling a warehouse control or management system to precisely control the position, acceleration/deceleration, and speed of the carriages 104.

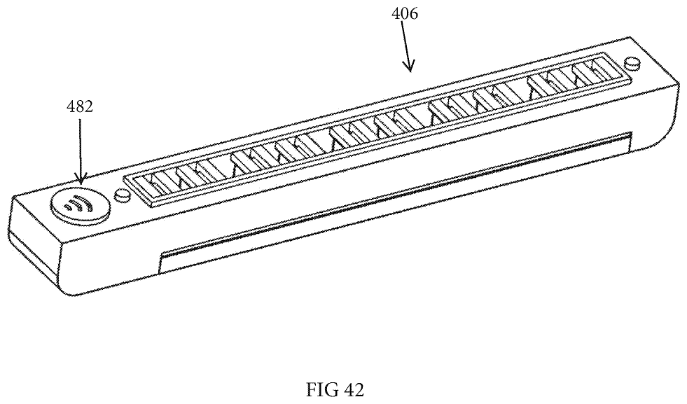

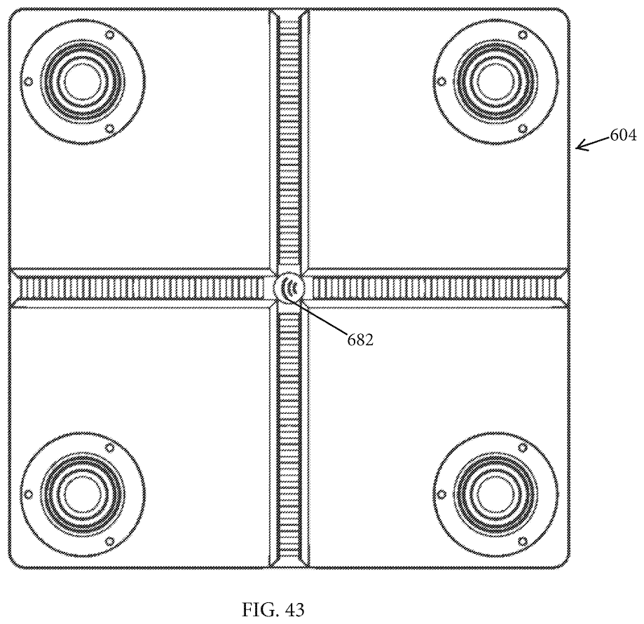

As will be more fully described below in reference to FIGS. 42-45, conveyor system 100 may include a carriage tracking system, such as in the form of wireless devices, such as RFID readers and tags, to track the location of the carriages within the system 100. A primary advantage of the linear drive conveyor system is that mechanical lifts or transfers are not necessary to transfer carriages from one conveyor line to another. The linear drive conveyor system may be adapted and configured to supplement or replace many commonly known and commercially available material handling systems including automated storage and retrieval systems (ASRS), linear sorters, automated mixed case palletizers, and standard conveyor, in addition to many others. The linear drive conveyor system may be integrated with human or robotic functions, such as robotic pick cells and goods-to-person (GTP) workstations. The linear drive conveyor system 100 is well suited for implementation and integration of neural net processing and artificial intelligence learning programs which may enable dynamic routing techniques to increase throughput and organization of operations in a warehouse facility.

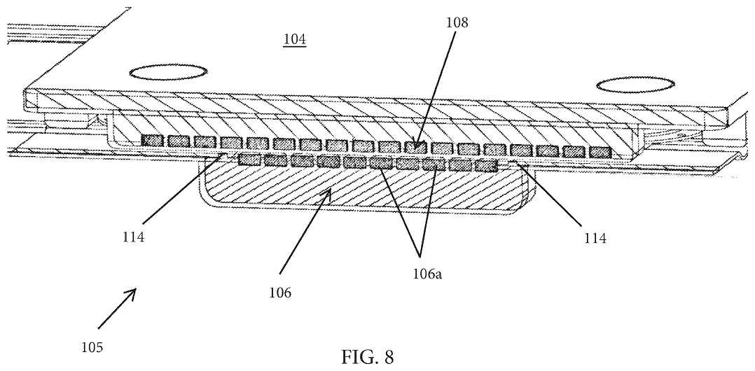

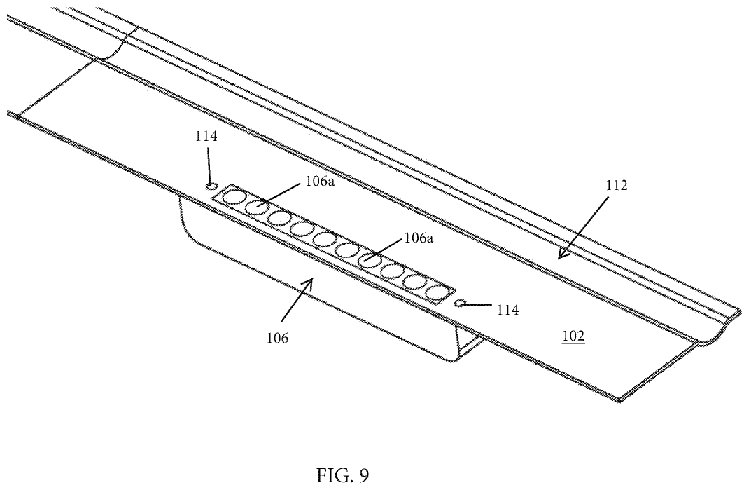

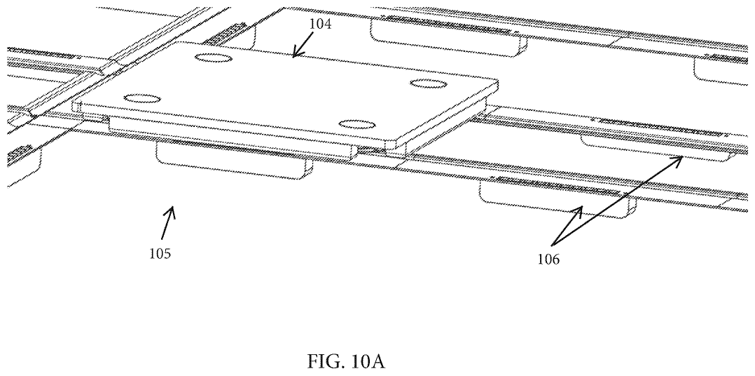

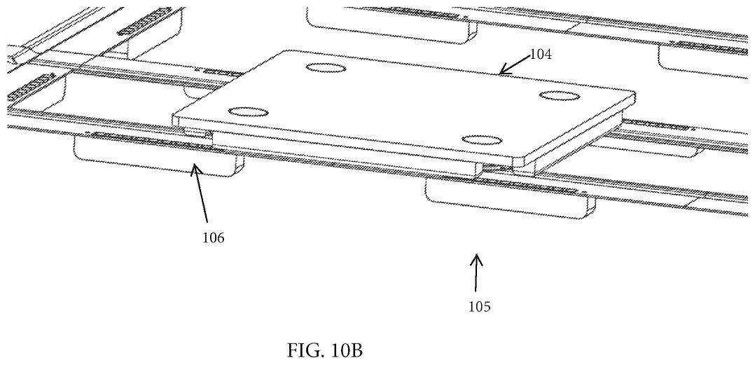

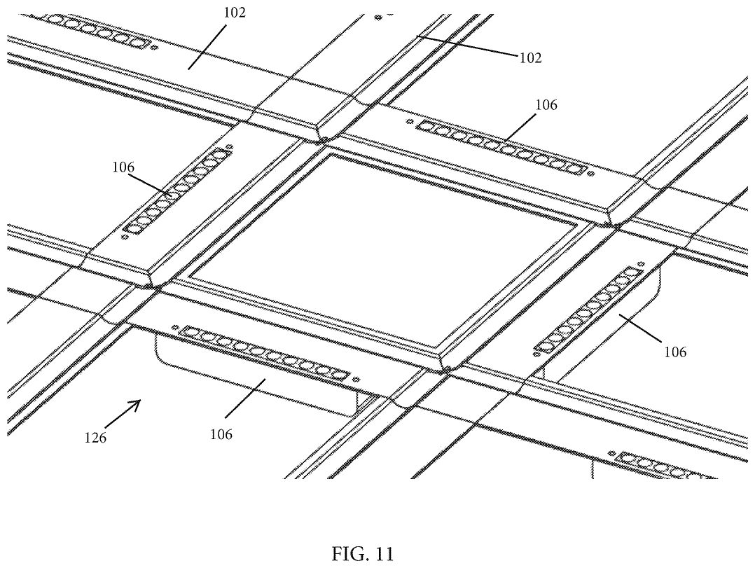

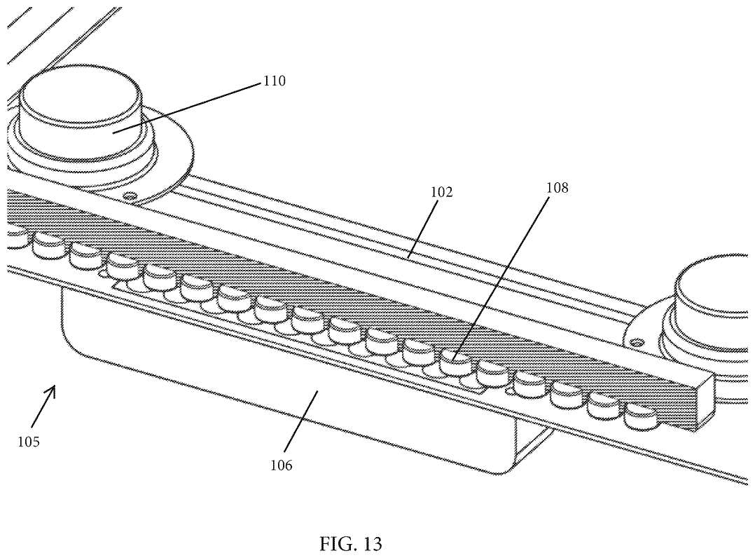

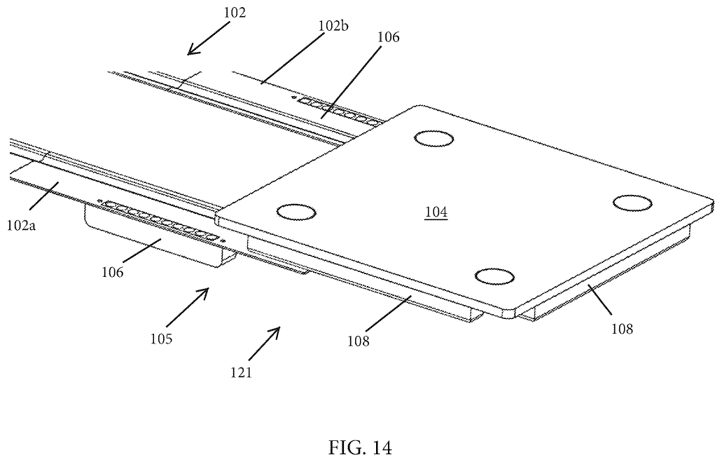

Referring now to the illustrative embodiment of FIGS. 1-16, the linear drive conveyor system 100 is provided for transporting goods within a warehouse facility (e.g. e-commerce fulfilment center). The linear drive conveyor system 100 includes an array of guide tracks 102 arranged throughout the warehouse facility and a plurality of carriage 104 supported on and moveable along the guide tracks 102. The carriages 104 support goods (e.g. individual items, cases of items, etc.) for transport within the warehouse facility. A linear drive system 105, including an array of magnetic linear drive motors or drivers 106, propel the carriage 104 along the guide tracks 102 in response to control from a warehouse control system. As will be more fully described below, the drivers 106 remotely push and/or pull the carriages 104 without contacting the carriages 104.

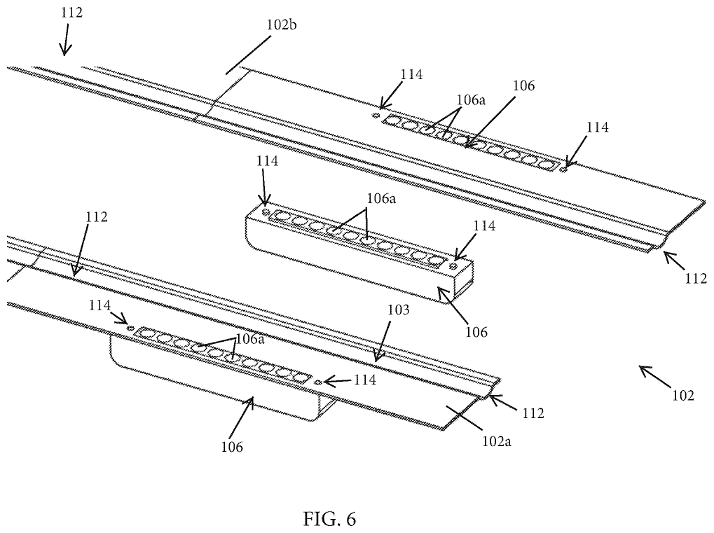

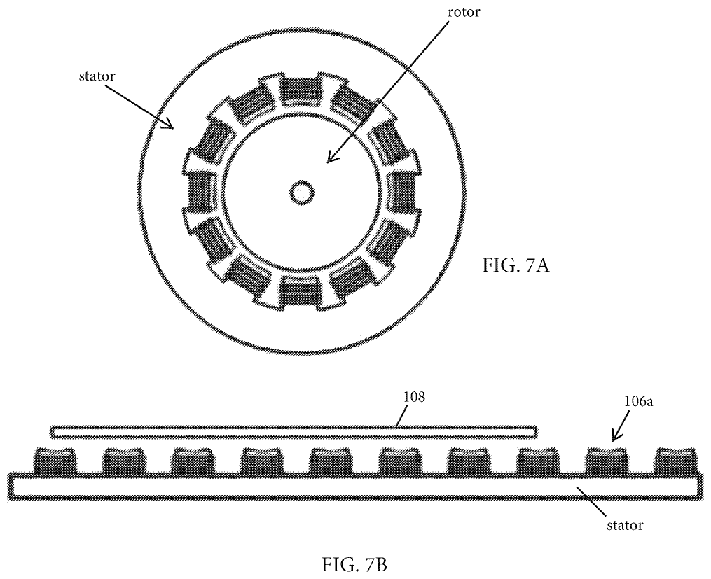

Referring to FIGS. 6, 7, and 9, drivers 106 each include a drive coil 106a (see in particular flat, linear stator of FIG. 7B) fixed to or positioned alongside the guide track 102, and the drive coil 106a is addressable and controllable by the warehouse control system. A magnetic array 108 of magnetic elements is coupled to each carriage 104, and the drive coil 106a of the driver 106 magnetically influences or interacts with the magnetic array 108. In this manner, the drive coil 106a of driver 106 and the magnetic array 108 of a nearby carriage 104 form a cooperative pair of elements, which effectively form the linear drive system responsible for moving the carriages 104. In other words, the drive coil 106a and magnetic arrays 108 of carriages 104 must coexist and interplay with one another in order to provide transport vehicles within the warehouse system.

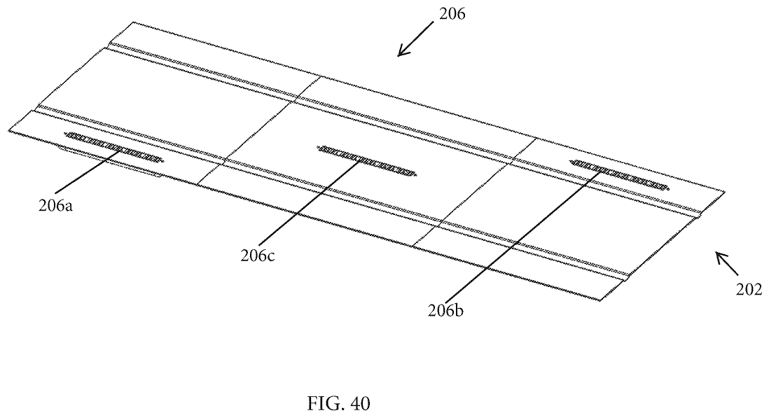

In alternate embodiment, the linear drive conveyor system 100 includes an alternating driver 206 configured to move the carriages 104. As shown in FIG. 40, driver 206 includes first and second drivers 206a, 206b spaced apart from each other are provided on the sides of the guide track 202. Driver system 206 may further include a third driver 206c spaced apart from drivers 206a, 206b, which is provided at a central or near-central position relative to the guide track 202.

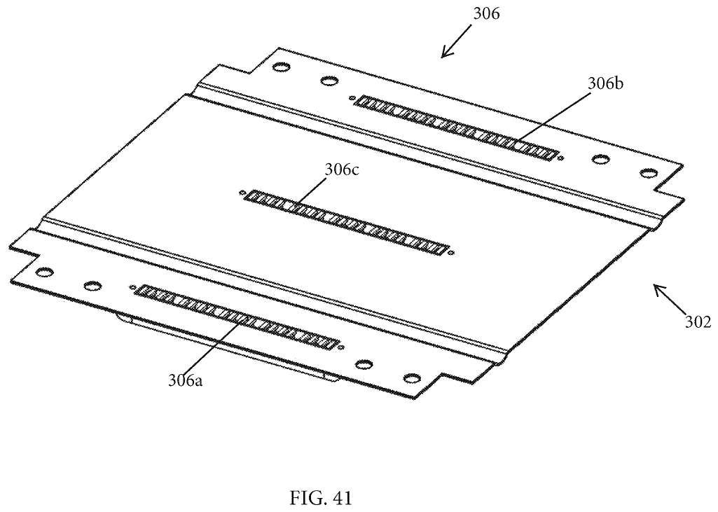

In yet another embodiment, an alternating driver 306, as depicted in FIG. 41, includes drivers 306a, 306b, and 306c parallel and proportionally spaced apart from each other are provided on the guide track 302. The shape, length, and thickness of the driver 206, 306 may be provided without departing from the scope and intent of the disclosure. For example, the length of the drivers 206a, 206b, 306a, 306b, may be longer than, equal to, shorter than the length of the driver 206c, 206c and hence have a different number of driver coils.

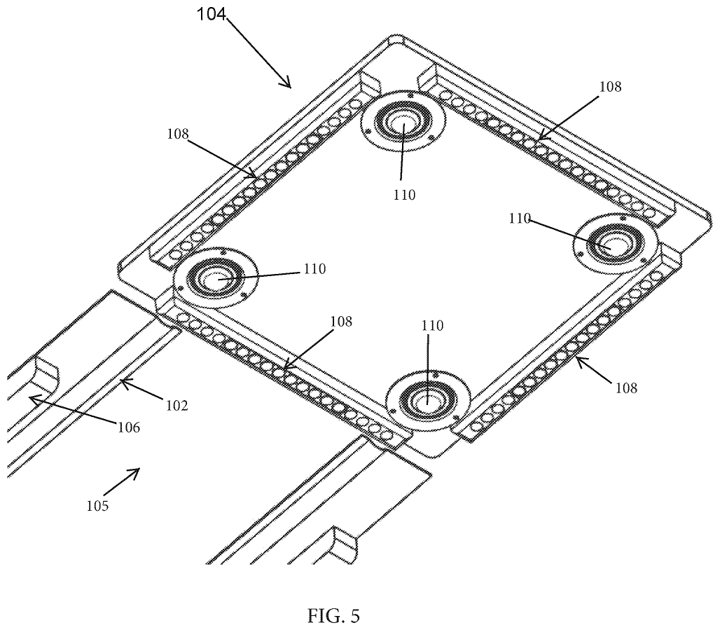

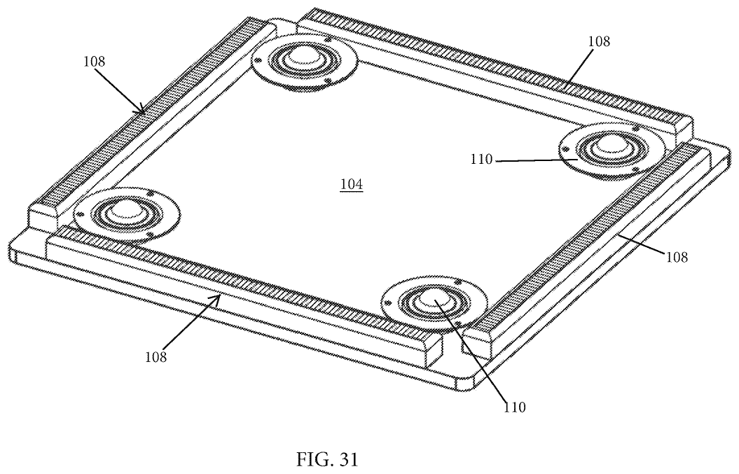

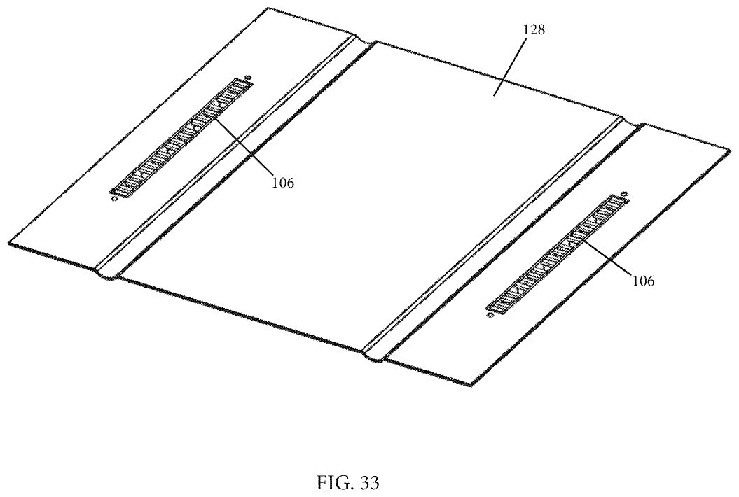

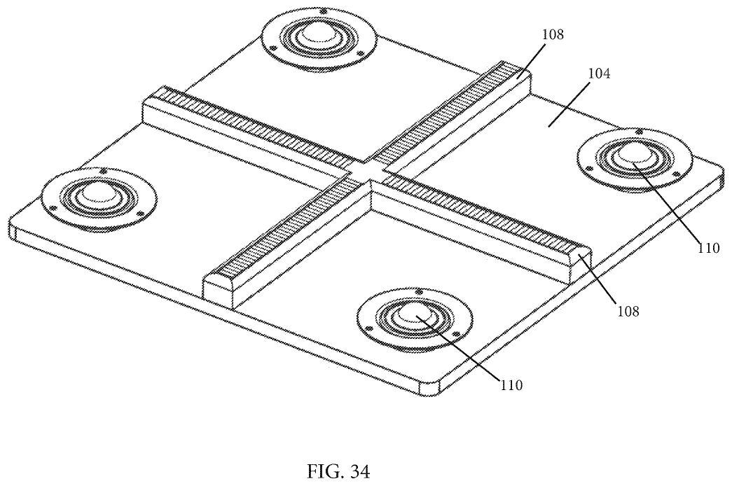

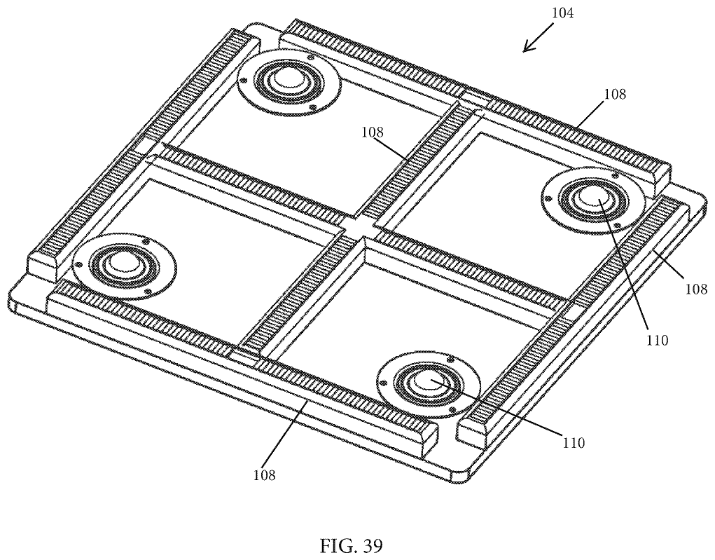

Referring to FIG. 5, in the illustrated embodiment, magnetic arrays 108 each include a plurality of magnetic elements, such as ceramic or rare earth magnets, which may have a circular configuration, which are arranged in linear arrays along each side and edge of carriage 104. The magnets may be arranged with alternating magnetic poles as described below. Alternately, the magnetic elements may have different configurations, such as bar-shaped configurations, such as shown in FIGS. 31, 34, 39, and 44, and further arranged in various configurations, such as shown in FIGS. 34, 39, and 43. For example, as best seen in FIG. 31, the magnetic elements may have a bar-shaped configuration that are arranged in linear arrays around each edge of carriage 104. Alternately, as best seen in FIG. 34, the magnetic elements may have a bar-shaped configuration that are arranged in two linear arrays that form a cross-shaped configuration whose center is located at the center of the carriage. Optionally, carriage 104 may have a combination of arrays-such as the four linear arrays arranged at the four edges of the carriage in combination with the cross-shaped configuration extending between each side of opposed arrays, such as shown in FIG. 39.

Drivers 106 may be located in various locations, such as shown in FIGS. 1,6, 12A, 17, 18, 19, 21, 32, 36, 40, 41, and 45. For example, drivers 106 may be provided on each edge or side of the guide track 102, which cooperate with magnetic arrays 108 provided on each side of the carriage 104 (i.e. a “dual drive”), such as illustrated in FIGS. 1-6, 10A-15, and 17-20.

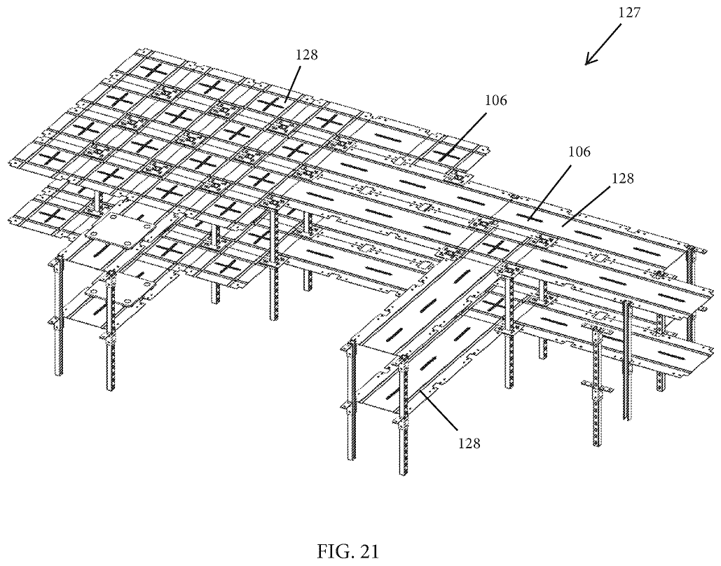

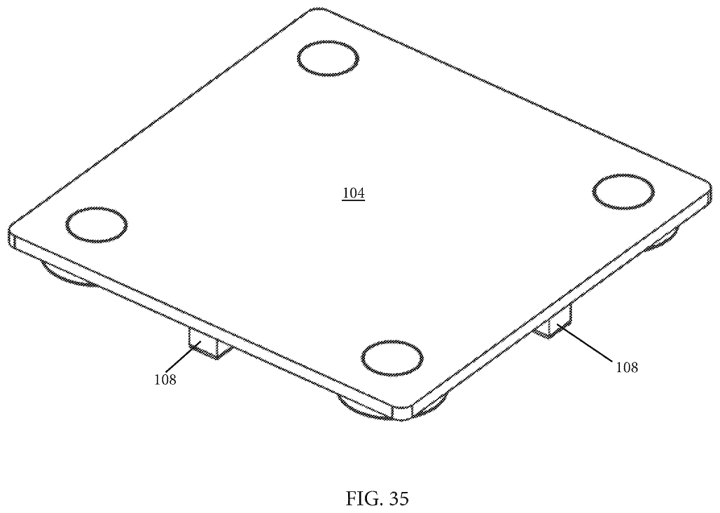

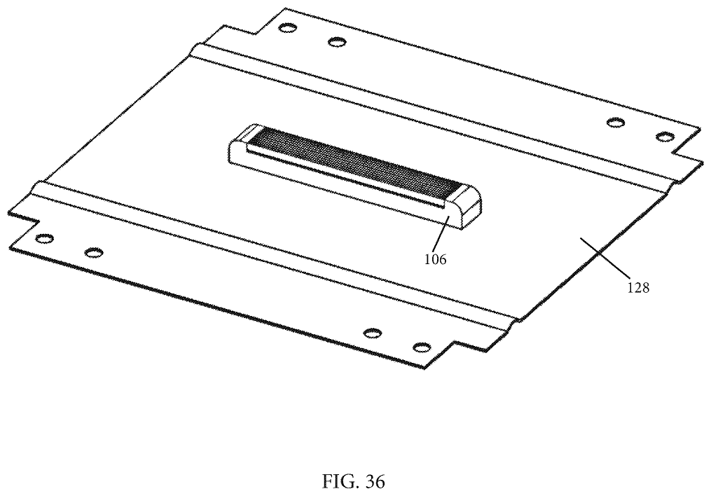

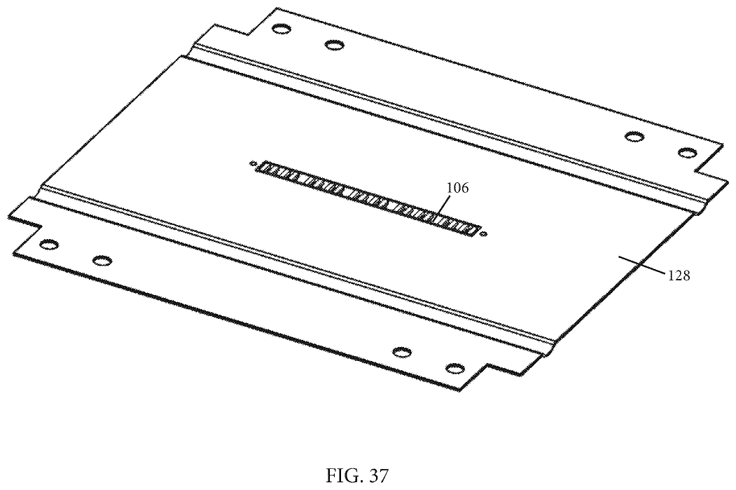

Optionally a driver 106 may be located at a central position along the guide tracks 102, such as shown in FIGS. 6, 40 and 41, either in addition to the drivers located on each side of the guide track (FIGS. 6 and 41) or in an alternating arrangement such as shown in FIG. 40. Alternately, as will be more fully described in reference to FIG. 21, a single driver 106 may be provided at a central position along the guide tracks 102 which cooperates with a single magnetic array 106 at a central portion of the carriage 104 (i.e. a “single drive”), as illustrated in FIGS. 21-22, and 34-37.

It will be appreciated that in systems having right angle transfer (RAT) locations 126, the carriage requires magnetic arrays 108 along both axes to allow the carriages to be driven in both travel directions. The configuration and quantity of drivers and carriage magnetic arrays may be chosen as a function of required power, capacity, resource allocation, etc. A single drive reduces the number of required drives and halves the required magnets on the carriage 104.

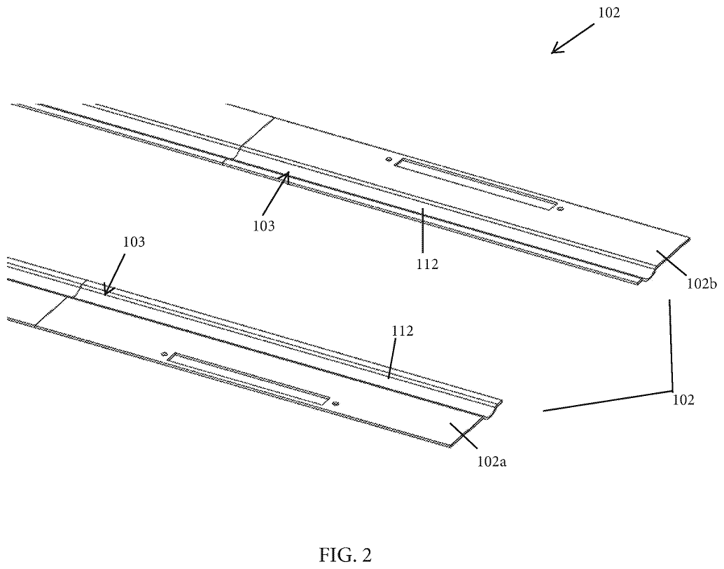

In addition the carriages 104 each include a plurality or set of low-friction roller supports 110 (FIGS. 4 and 5) to support the carriage 104 at a support surface 103 (FIG. 2) of the guide tracks 102. The roller supports 110 of the illustrative embodiment are provided in the form of four (4) ball transfer bearings per carriage 104. Optionally, the ball transfer bearings are shock absorbing ball transfer bearings, such as bearings commercially available under the part name “shock-absorbing flange-mount ball transfers” from McMaster-Carr® Supply Company of Elmhurst, IL, for example. The shock absorbing nature of these bearings may reduce or eliminate noise during movement of the carriages 104 along the guide tracks 102 and may extend the useful life of the carriages 104 and the guide tracks 102. The roller supports 110 provide an “air gap’ or separation distance between the carriage 104, the carriage magnet array 108, and the drivers 106 in a manner that optimizes the influence of the drivers 106 on the carriage magnet array 108. While the support element supporting the carriage 104 on the guide tracks 102 is described herein as roller supports (e.g. ball transfer bearings) having a single moving part (i.e. the ball bearing), it is contemplated that the support element may be provided with no moving parts.

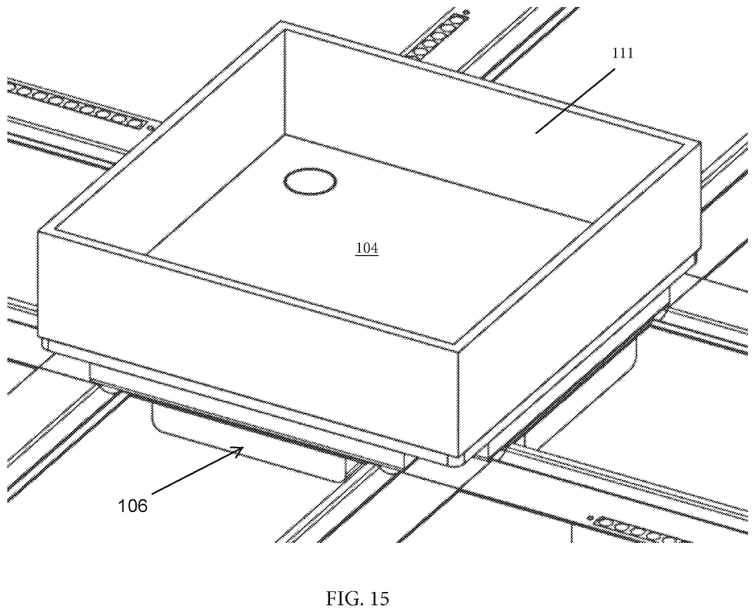

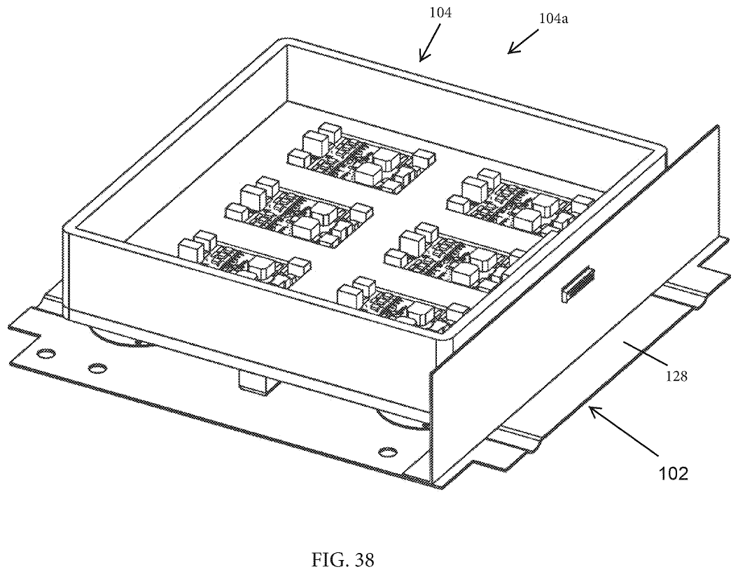

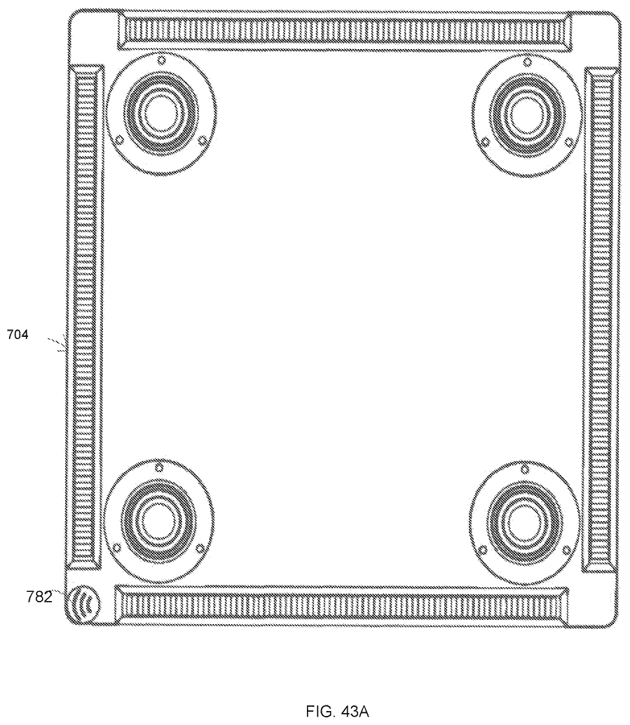

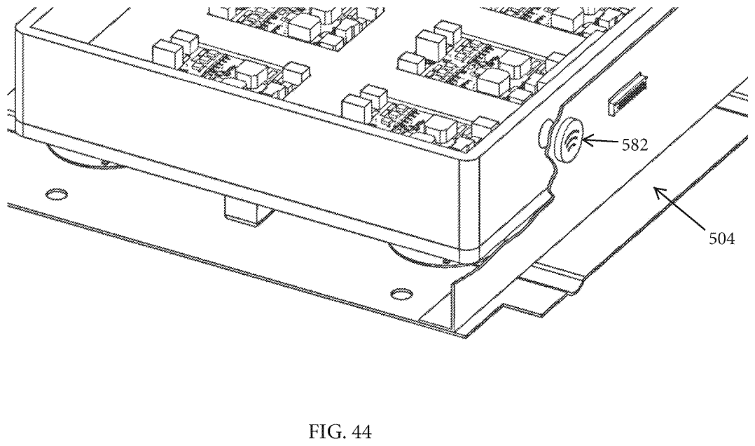

For example, the carriage 104 may be supported at the guide tracks with standoffs formed of a low friction material, such as a self-lubricating plastic (e.g. polytetrafluoroethylene (PTFE)) and/or high resiliency material (e.g. ultra-high molecular weight plastic (UHMW)), for example. Walls or lips 111 may be provided with the carriage 104 to retain items on the carriage 104, as depicted in FIG. 15. A compartment system may also be provided with carriages, such as shown in FIGS. 38 and 44. It is contemplated that service carriages may be adapted to provide services to the system, such as a “cleaner carriage” having brushes and a vacuum to clean the rails of the system, or a “sensor carriage” that measures rail smoothness and drive smoothness with inertial measurement units (IMUs), for example.

Carriages 104 may include an “active carriage” 104a (FIG. 38) or test carriage plate having predefined connections and control protocols may be provided for connecting configuring new devices, such as third-party requirements (e.g. customer specific parameters, etc.) or newly installed drivers, for example, or for automatic testing and quality assurance checks during the assembly process of a linear drive conveyor system 100 in a facility, and/or for post process testing/loading.

As will be more fully described in reference to FIG. 44, another carriage 504 may be directed into a “smart bay” having a mechanism to pull the carriage into the bay and engage a harness connecting to the device (e.g. computer, controller, etc.) on the carriage. The smart bay reads an RFID device 582, such as a RFID tag on the carriage. A central control system of the smart bay identifies the device on the carriage and the smart bay that the carriage is in. Power to the smart bay is then turned on. The central control initiates a wake signal for that bay. The carriage is powered on and connected to a remote system which loads predefined information (e.g. a computer image) to the device on the carriage and may then perform a predefined test to validate the information load. Once completed, the device on the carriage is signaled to shut down, or the carriage is signaled to drop power to the device. The power to the smart bay is turned off. The carriage is ejected into the linear drive conveyor system 100 and routed to its required location.

In another embodiment, the smart bay comprises a wireless device in the form of near-field communication (NFC) circuitry having an NFC controller coupled with an antenna element and a processing unit may be included to read electronic tags and/or connect with another NFC-enabled carriage 104. In yet another embodiment, the active carriage 104a may connected with the smart bay via such as Bluetooth protocol, Bluetooth low-energy (BLE) protocol, ultra-wideband (UWB) protocol, or any other suitable type or wireless communication protocol.

Optionally, the carriage is formed of a non-ferrous material (e.g. recycled plastic, aluminum, carbon fiber, etc.). In the illustrated embodiments, the carriage 104 includes a square plate and the guide tracks 102 are laid out in a ninety degree grid. It will be appreciated that a rectangular carriage plate may also be utilized, given that the guide tracks are appropriately spaced apart in the respective directions to accommodate a rectangular plate. It is also contemplated that an equilateral triangle-shaped carriage may be utilized with a guide track array that is laid out with guide tracks laid out in three directions and having 120 degree intersections between the guide tracks. Other shapes of carriage plates and guide tracks layouts may also be utilized, such as shown and described in reference to FIGS. 17, and 21, for example. Optionally, the guide tracks are formed from aluminum or other non-ferrous material, such as by extruding, stamping, molding, etc.

As a result of the permanent magnet system 108 of the carriage 104 and the iron core of the linear magnetic drivers 106, during a power loss, carriages in motion will automatically come to a stop. The carriage magnets are attracted to the iron cores of the drivers 106 in a non-energized mode and will provide a stopping force when a power loss occurs, thus providing an inherent safety feature. Mechanical stopping devices may be utilized in some instances, such as at induct and removal points 121 (FIG. 14). For example, spring return solenoids may be used to provide a mechanical stop where required. Regenerative breaking could be incorporated into the system to increase efficiency as energy could then be consumed as well as captured. Spring return solenoids or deployable pins may be provided with inclined and declined portions of the guide track to prevent backsliding of carriages during a power loss, such as carriages transporting heavy loads.

Each guide track 102 includes a pair of spaced apart side rails 102a and 102b (FIG. 2). Each of the side rails includes a channel or groove 112 formed therein to receive a portion of one of the roller supports 110. The channel 112 retains the roller support 110 in a desired position along the side rail 102a or 102b. The guide tracks may be extruded or stamped, and modular segments of the guide track may be interchangeable, such that side rails 102a and 102b do not require unique designs or forms, thus reducing unique parts in the linear drive conveyor system 100. The channel 112 and/or the support surface 103 of the side rails 102a and 102b may be lined or coated with a low friction material, such as a self-lubricating plastic (e.g. polytetrafluoroethylene (PTFE)) and/or high resiliency material (e.g. ultra-high molecular weight plastic (UHMW)), for example. Tracks 102 in the form of a pair side rails 102a, 102b are depicted in FIGS. 1-6, 8-15, and 17-20.

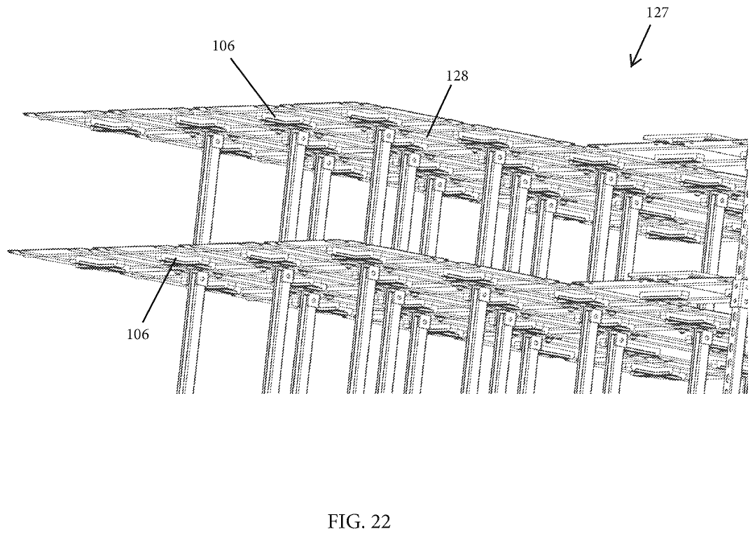

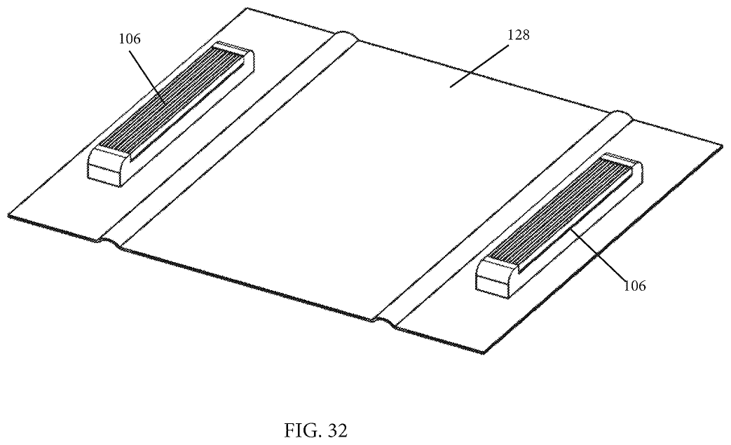

In another embodiment, guide tracks 102 may be provided in the form of guide trays/frames 128 are depicted in FIGS. 21-22, 32-33, and 36-37. Guide trays 128 are configured with channels 112 similar to side rails 102a, 102b. The unitary or solid connection between the channels 112 of the guide trays 128 may provide for increase strength and stiffness of the carriage support surface, and may enable a reduction in support infrastructure for supporting the support surface. Examples of support infrastructure are depicted in FIGS. 21 and 22.

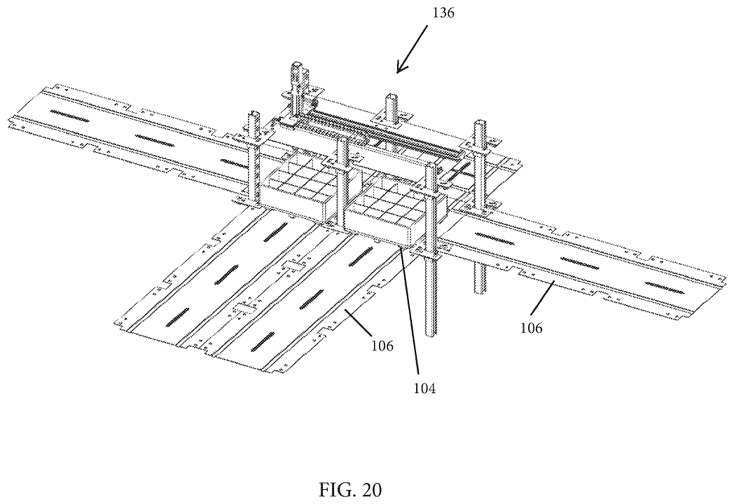

The linear drive conveyor system 100 may be formed with only straight segments of guide tracks 102 and transfers 126 in configurations that provide solutions for sortation, transportation, picking workstations (e.g. robotic picking cells), storage and replenishment. For example, a routing and buffering system 127, in the form of an arrangement of linear drive conveyor systems 100 as illustrated in FIGS. 21 and 22, may be provided for enabling efficient sequencing and transferring of goods within a facility. For another example, robotic cells 136 (FIG. 20) can be incorporated or positioned alongside guide tracks 102, in which the integration enables the robot 136 to interact with a carriage that has been precisely positioned, without transferring the items from the carriage 104. The robotic cell 136 is provided with status and identification of the carriages. Multiple paths can be provided proximate the robotic cell 136 allowing for efficient routing of both donor (e.g. inventory) carriages or totes and destination (e.g. order) carriages or totes. The linear drive conveyor system 100 may also be configured for human interfaces, such as integration with goods to person (GTP) order fulfilment.

Due to the properties and advantages of linear induction motors, long straight segments of guide tracks 102 may enable high carriage speeds, which may facilitate improved throughput.

Carriage presence sensors 114, such as in the form of Hall Effect or magnetic proximity sensors, may be provided at each driver 106. The sensors 114 communicate a location of the carriage 104 relative to the driver 106 to the warehouse control system to enable the warehouse control system to precisely control the drivers 106 to position carriages at precise locations within the facility. Alternately, each carriage presence sensor 114 may comprise a Microelectromechanical System (MEMS) sensor that is miniaturized through combination of micromachines, microelectronics, and semiconductor process technologies.

In another embodiment, the carriage presence sensor, the optical sensor, mechanical sensor, or the like can be formed on the same substrate without departing from the scope and intent of the disclosure. The carriage presence sensors 114 detect magnetic fields as well as polarity of nearby magnetic fields. Optionally, a pair of carriage presence sensors 114 are provided at each of the drivers 106, including: a first sensor at one end (e.g. an upstream side) of a particular driver to detect entry of the carriage as it moves into proximity (within a zone of influence of the driver) with that driver; and a second sensor at the opposite end (e.g. a downstream side) of the particular driver to detect exit of the carriage as it moves out of proximity (out of the zone of influence of the driver) with that driver, which can be used to determine entry timing and general pulse positioning/velocity. In this manner, the warehouse control system is enabled to activate or deactivate the drive coil 106a (or portion of the drive coil 106a) of a particular driver 106 to accelerate, decelerate, or maintain the travel rate of a carriage as it enters into proximity with the driver and as the carriage exits or leaves the zone of influence of that carriage. The carriage presence sensors 114 may be configured to determine occupancy (i.e. whether a carriage is in proximity to a particular driver), velocity information (i.e. the rate at which a carriage is passing a particular driver), and zone-to-zone or driver-to-driver motion coordination or sequencing, in addition to determining the entry and exit of a carriage from a driver's zone of influence. While it will be appreciated that other sensors may be utilized (e.g. optical or mechanical sensors) in addition to or alternatively to magnetic proximity sensors, it is preferable for simplicity and reduction of components to utilize magnetic proximity sensors solely.

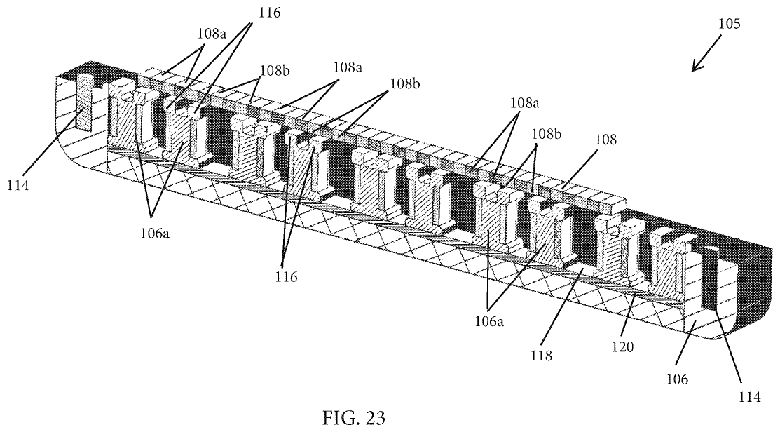

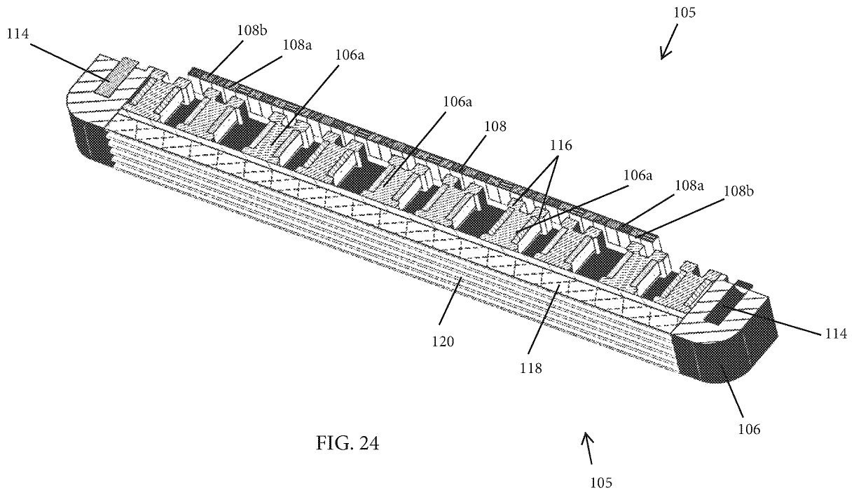

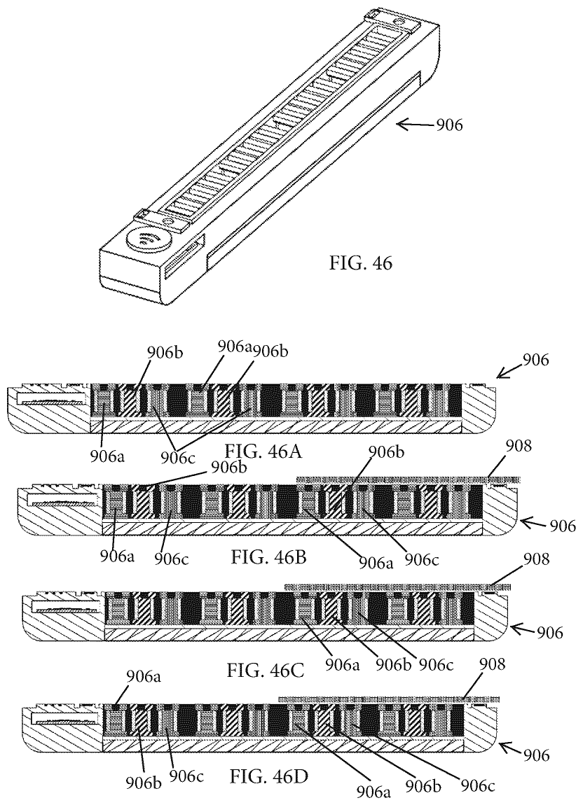

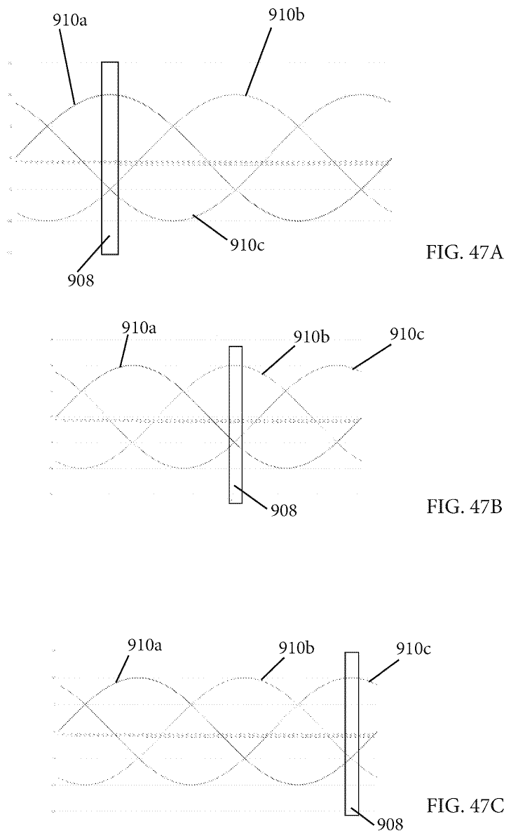

Optionally, the drivers 106 are configured as 2-phase stepper motors (such as motors utilizing Application Specific Integrated Circuits (ASICs), for example), as illustrated in FIGS. 23-29B, though other phase configurations for linear induction motors as known in the art may be utilized to drive the carriages, such as a 3-phase linear induction motor, for example, such as shown in FIGS. 46-46D. Other types of drivers, such as MEMS actuators, brushless DC motors, or the like can be used without departing from the scope and intent of the disclosure.

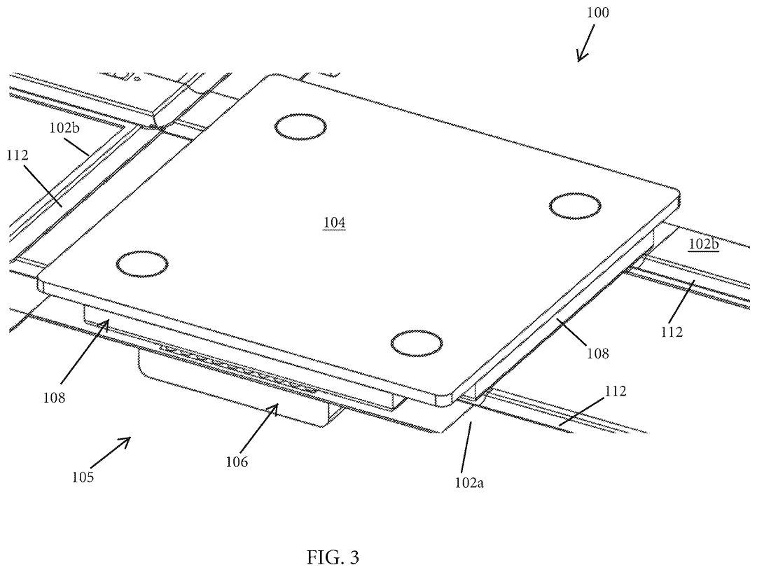

In the illustrated embodiment of FIGS. 23-29B, the linear drive system 105 includes the 2-phase stepper type linear induction motor or driver 106 (FIGS. 1, 3-6, 8-15, and 23-29B), the carriage magnet array 108 (FIGS. 3-5, 7B, 8, and 23-29B), carriage presence sensors 114 (FIGS. 6, 8-9, 13, and 23-29B), drive coil 106a (FIGS. 6, 7B-15, and 23-29B), laminated plate stators 116 at each element of the drive coil 106a (FIGS. 23-29B), a shunt plate 118 (FIGS. 23-29B; e.g. iron shunt plate), and a heat sink 120 (FIGS. 23-29B), which may be an optional element for the linear induction motor. It is contemplated to utilize a microcontroller and circuits to accomplish similar step control functionality as that enabled by ASICs, in addition to, or as an alternative to the abovementioned ASICs, which may enable higher power/capacity capabilities. Examples of stepper ASICs include a type similar to that utilized in MCC conveyors marketed and sold by Dematic Corp. of Grand Rapids, MI, and include an externally mounted stepper motor. The stepper motors may include brushless direct current motors (BLDC) paired or in coordination with field oriented controls (FOC) and an internally mounted drive. It will be appreciated that different forms of ASICs may occupy the same footprint but provide different amounts of drive current and control.

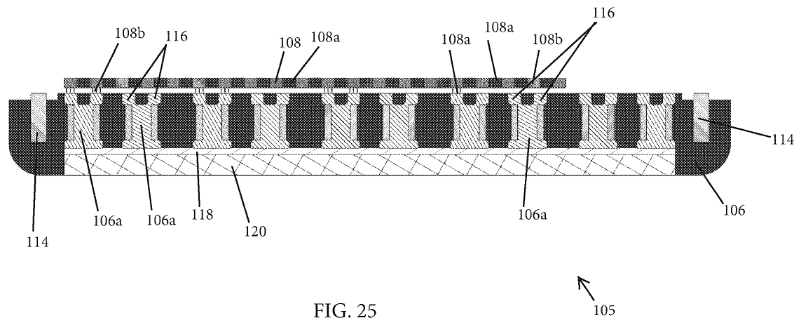

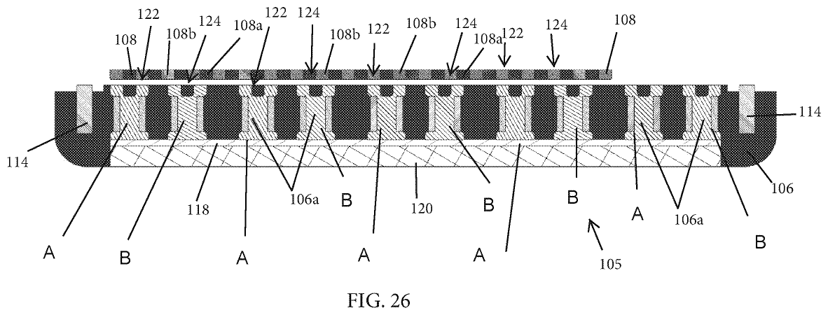

Referring to FIG. 25, an illustrative diagram is provided of the linear induction motor 105a in an “idle state” in which the magnetic attraction of the drive coil 106a is activated/deactivated to hold or maintain the carriage in a static position. FIGS. 26-28 provide sequential illustrative diagrams for the operation or commutation of the linear induction motor 105a in which the warehouse control system controls the magnetic attraction of the drive coil 106a to drive the carriages 104. Each drive coil 106a includes a pair of coils, with every other coil 106a having a pair of “A coils” 122 (depicted in FIG. 26) and the intervening every other coil 106a having a pair of “B coils” 124 (depicted in FIG. 26). The warehouse control system is operable to individually address or control the A coils 122 independent of the B coils 124. As such, the A coil pairs 122 and the B coil pairs 124 can each be polarized to north or south, as controlled by the warehouse control system. The magnetic array 108 of the carriage 104 includes north pole portions 108a (shown in FIGS. 23-29B) and south pole portions 108b (shown in FIGS. 23-29B). Depending on the pole configuration of A coils 122 and the B coils 124, the coils 122 and 124 influence (e.g. push or pull) the north pole portions 108a and south pole portions 108b of the carriage's magnetic array 108. The arrangement and quantity of A coils 122, B coils 124, north pole portions 108a, and south pole portions 108b enable the warehouse control system to precisely control the movement and positioning of carriages 104 within the system 100.

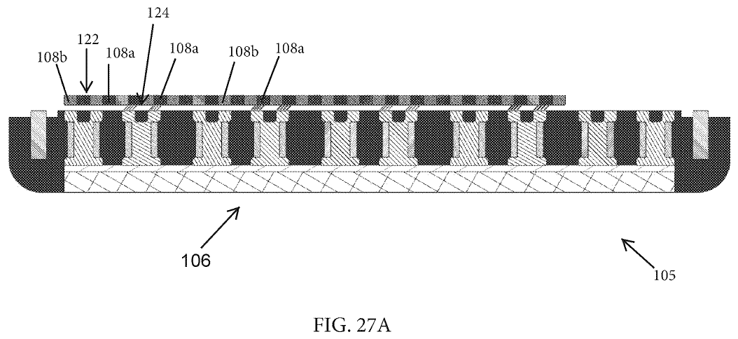

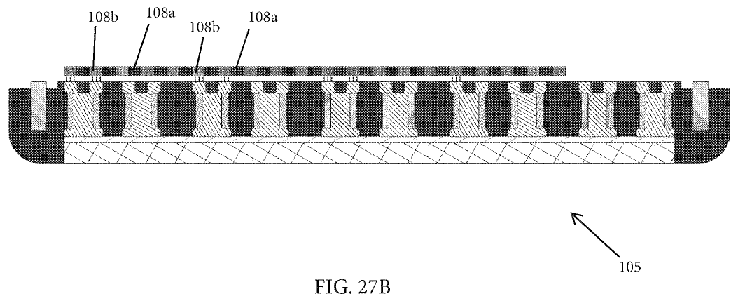

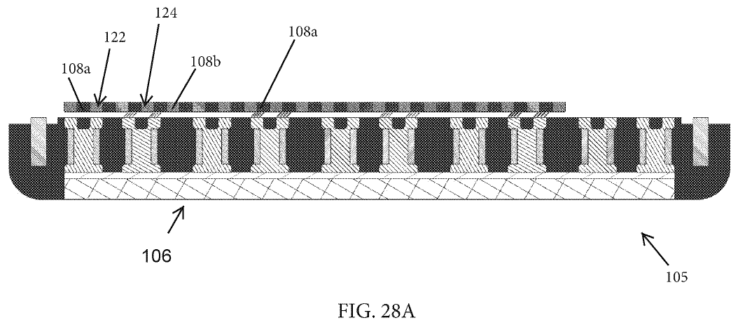

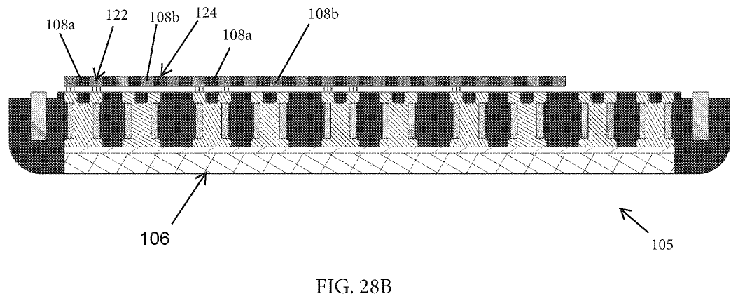

The following provides an example of the relative interaction of the elements of the linear drive system 105, as controlled by the warehouse control system under a stepping control sequence (see FIGS. 26-28B). As illustrated in FIG. 26, the A coils 122 are aligned with south pole portions 108b on the carriage array 108, and the B coils 124 are each balanced or split over a north pole portion 108a and a south pole portion 108b. When the warehouse control system activates or polarizes the B coils 124 to a south polar setting, they attract the north pole portions 108a of the carriage magnet array 108, to cause the carriage 104 to be pulled forward (see FIG. 27A), until the B coils 124 are generally aligned with the north pole portions 108a, at which point the A coils 122 are each balanced or split over a north pole portion 108a and a south pole portion 108b (FIG. 27B). When the warehouse control system activates or polarizes the A coils 122 to a south polar setting, they attract the north pole portions 108a of the carriage magnet array 108, to cause the carriage 104 to be pulled forward (see FIG. 28A), until the A coils 122 are generally aligned with the north pole portions 108a, at which point the B coils 124 are each balanced or split over a north pole portion 108a and a south pole portion 108b (FIG. 28B). When properly sequenced and controlled by the warehouse control system, the activation and deactivation of the A and B coils 122 and 124 enable the carriages to move forward along the guide tracks (e.g. constant velocity movement, or accelerated movement). The above listed steps may be reversed to decelerate, stop, and/or reverse the carriage 104 motion.

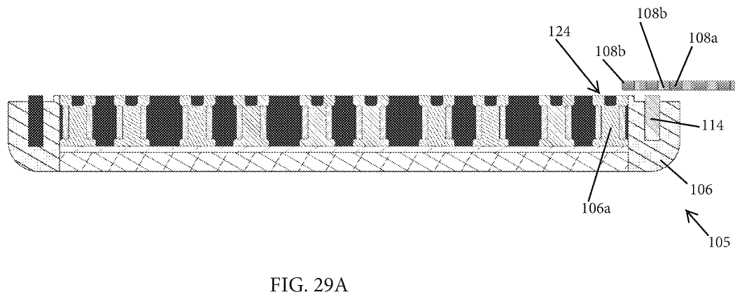

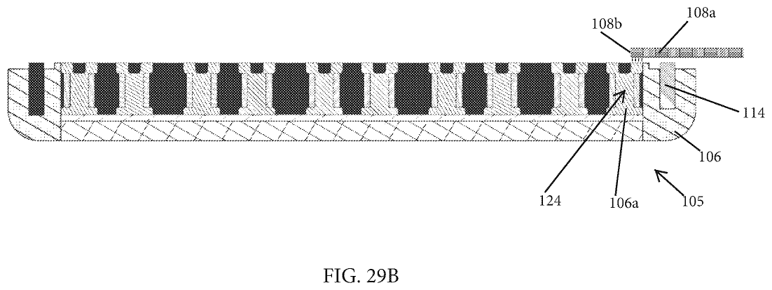

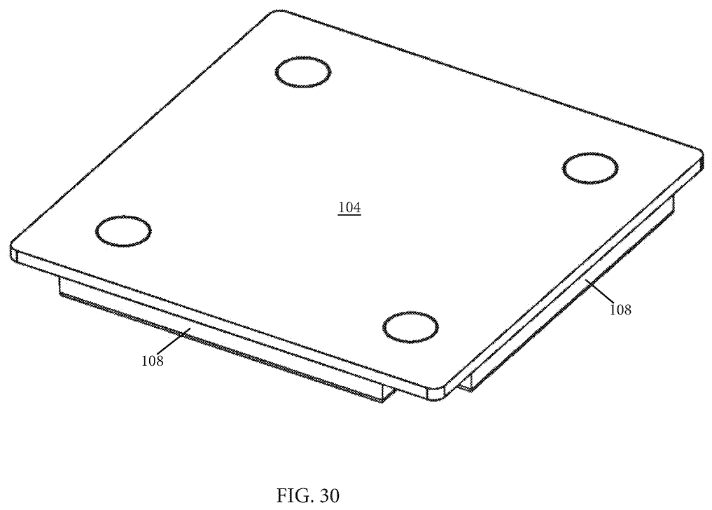

The following provides an example of the relative interaction of the elements of the linear drive system 105, as controlled by the warehouse control system under a synchronization control sequence to effectuate zone to zone motion control (see FIGS. 29A and 29B). The zone to zone (i.e. driver to driver) motion of the carriages 104 is controlled and regulated as a function of peer to peer communication (via the warehouse control system) along with entry and exit information from the carriage presence sensors 114. The carriage presence sensors 114 are capable of sensing incoming magnetic poles or polarity of the carriage magnetic array 108 and the warehouse control system is operable to control the stepper motor of the driver 106 to coordinate what state the coils (122 and 124) are activated/deactivated to in order to maintain velocity, accelerate or decelerate a carriage 104. For example, as depicted sequentially in FIGS. 29A and 29B, the upstream carriage presence sensor 114 senses the south polarity of the nearest pole portion of the magnetic array 108 of the carriage 104. Based on the known distance between the carriage presence sensor 114 and the drive coils 122 and 124, the warehouse control system can activate/deactivate the coils 122, 124 in proper sequence and precision timing to control the movement of the carriage with a high level of precision and accuracy. As the first pole portion, i.e. south pole portion 108b, of the carriage magnetic array 108 approaches the first drive coil, i.e. B coil 124 of the driver 106, the warehouse control system polarizes the B coil 124 to a north polarity to attract or pull the first south pole portion 108b of the carriage (see FIG. 29A).

The arrangement and utilization of the 2-phase stepper drive 106 permits “microstepping”, or less than full step activation, to be performed at a 1/128th of a step, for example, which permits the carriage to be moved in increments of 1/128th of a single magnet width (i.e. the 1/128^{th} of the width of a particular pole portion of the magnetic array 108). Microstepping may provide additional benefits within the linear drive conveyor 100, such as reduction of noise or “driver chatter” which is commonly present in full-step operation of linear induction motors. It will be appreciated that other step intervals or sizes may be adapted for use in the system 100, for example, drivers may be configured to control the movement of the carriages 104 in ½ of a drive step, ¼ of a drive step, ⅛ of a drive step, 1/16 of a drive step, 1/32 of a drive step, 1/64 of a drive step, and 1/256^{th} of a drive step.

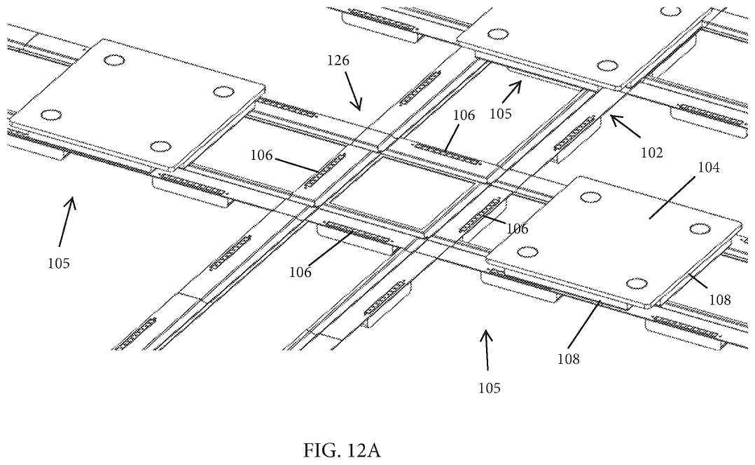

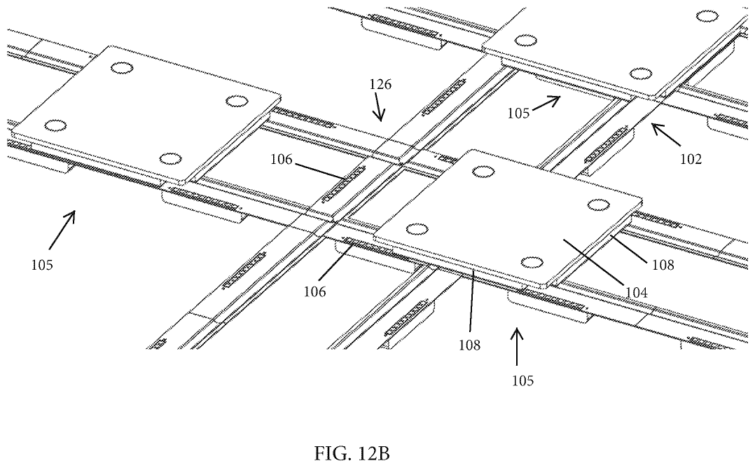

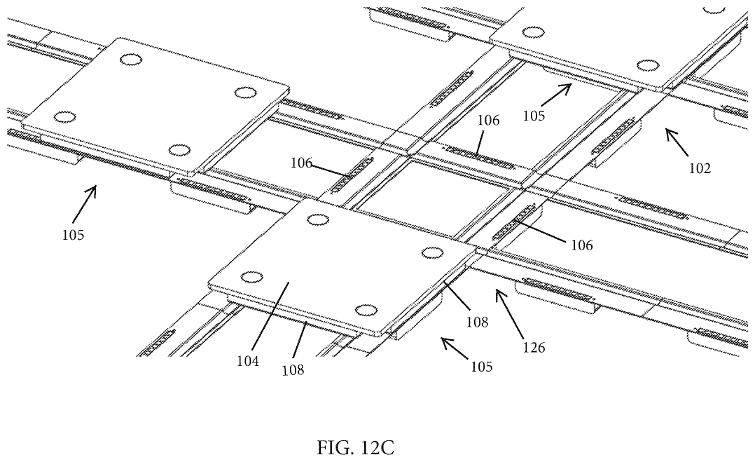

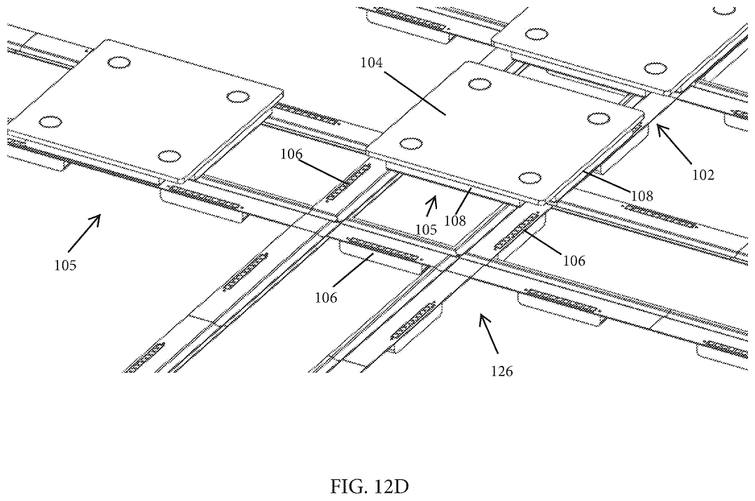

As noted above, the array of guide tracks 102 include one or more intersections of guide tracks 102 which represent or form transfer locations 126 for carriages 104 to transfer from one of the guide tracks 102 to another of the guide tracks 102 (FIGS. 1 and 11-12D). In the illustrated embodiments, the transfer locations 126 are “right angle transfers (RATs)” or ninety degree/perpendicular transfers. The RATs include drivers oriented in each guide track direction to enable the warehouse control system to re-direct or change the direction of a carriage 104. The transfer locations 126 require very minimal components, aside from appropriate guide tracks 102 and drivers 106, as compared to commonly available and known right angle transfer systems in typical conveyor systems. The transfer locations 126 do not require a change in elevation of any components or the carriage 104 to re-direct a carriage onto a new conveyor line (i.e. guide track). FIGS. 12A-12D depict sequential steps of an exemplary motion of a carriage 104 transferring from one guide track 102 to another perpendicular guide track 102.

The following provides an example of the control of the system 100 to transfer a carriage from one guide track 102 to a perpendicular one. A carriage 104 approaches a transfer location 126 (FIG. 12A) and the warehouse control system slows the carriage (FIG. 12B) utilizing the driver(s) 106 at the transfer 126 that are in line with the present guide track 102. The control system controls the driver(s) 106 to align the carriage 104 with the center point of the transfer location 126. The control system then activates the driver(s) 106 in line with the new, perpendicular guide track 102 to move the carriage 104 onto the new guide track 102. The carriage 104 is depicted as moving in one direction along the new guide track 102 in FIG. 12C and moving in another direction along the new guide track 102 in FIG. 12D. The system 100 utilizes the carriage presence sensors 114 on the drivers 106 (FIGS. 12A-12D) to detect the magnet arrays 108 of the carriage 104 to verify that the carriage is properly aligned in the transfer 126 in order to be free to move onto the new guide track 102. For example, the warehouse control system utilizes the presence sensors 114 on the drivers 106 in line with the new guide track 102 to verify that the magnet arrays 108 of the carriage are properly aligned over the drivers 106, which ensures that the carriage supports 110 are aligned with the channels 112 of the new guide tracks 102. Once alignment is verified, the carriage 104 is moveable in any of the four guide track directions of the transfer segment 126.

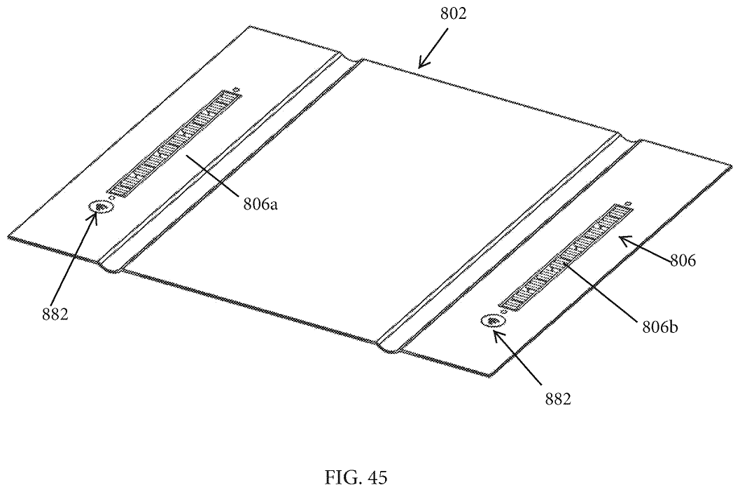

The linear drive conveyor 100 may include an RFID reader system disposed throughout the warehouse facility and in communication with the warehouse control system. For example, each carriage in the system 100 may include a wireless device, such a unique RFID tag that is readable by the RFID reader system. As best seen in FIG. 42, drivers 406 may include a wireless device 482, such as an RFID reader, mounted adjacent one of the carriage presence sensors. In this manner, when the drivers are mounted to the guide track, similar to carriage presence sensor, wireless devices 482 may be located in an opening provided in the guide tracks, such as best understood from FIG. 45, to face the carriages as they move over the drivers. In addition, wireless devices, such as RFID readers may be installed at decision locations (e.g. RATs 126) and carriage induction and removal points 121 (FIG. 14), for example.

As noted, each carriage may include a wireless device. As such, the warehouse control system is operable to track a position of each carriage relative to the drivers. In this manner, items may be identified before being placed on a carriage and thus only the carriage needs to be tracked within the system. In some examples, the linear drive conveyor system 100 may include a “find an item” locator (not shown) in the warehouse facility. Using a unique communication protocol, the locator can identify the item wrongly placed in the carriage or transferred by the carriage.

Now referring to FIGS. 42-45, various embodiments of a linear drive conveyor system including a wireless communication device are disclosed. The wireless communication device, e.g. NFC device, RFID device, a short-range communication device, or any other suitable wireless communication protocol for communication with the external device may be provided on various locations on the linear drive conveyor. In some examples, the RFID device may be mounted, integrated within, formed part of the carriage, guide rails, or fabricated from the same substrate of the carriage, guide rails. As shown in FIG. 42, a wireless device 482, such as an RFID tag, is coupled to an end of the driver system 406. In other examples, wireless devices 582, 682,782, such as RFID tags, can be coupled to a housing of the carriage 504, beneath the carriage 604, 704 such as near center or center position of the carriage 604 or at one of the four corners of the carriage 704. In yet another embodiment, the RFID tags 882 proximal to the drivers 806a, 806b are coupled to each side of the guide rail 802, as depicted in FIG. 48. Other than transmitting data such as carriage location, wrong item ID to the RFID reader system, the data may include carriage status such as failure/no response signal, signal strength, and the like. For other details of the drivers, guide tracks, and the carriages, reference is made to drivers 106, tracks 102, and carriages 104, respectively.

As noted above, a linear drive conveyor system 100 may include 3-phase drivers, and further optionally 3-phase drivers with a much lower voltage (24-48 VDC) than conventional drivers. Similar to the stepping version, magnetic array 908 uses permanent magnets to provide fixed fields that can be attracted or repelled thus causing the linear motion. In a step based system the two phases are 120° out of phase with each other, while in the 3-phase configuration, each of the three phases is 120° out of phase with the other two phases. This allows for greater overlap of “steps” resulting in higher torque, efficiency and possible position accuracy.

Referring to FIGS. 46 and 46A-46D, rather than having a pair of “A coils” and a pairs of “B coils”, each drive coil of 3-phase driver 906 includes set of three coils, namely A, B, and C coils (coil 906a, coil 906b, and coil 906c, respectively). As best seen in FIG. 47A, using 3 phases and examining the peak of phase A (910a), phase A has the highest magnitude (power) of the three while being in a positive polarity, this will case an attractive force in this state. Phase B (910b) and C (910c) are inverse but at approximately ½ the magnitude of A. This causes both attractive and repulsive forces based on the magnets that they are in proximity of. As the sine wave continues these “in-between” drive segments provide the direction of motion.

Referring to FIG. 47B, examining the peak of phase B (910b), phase B has the highest magnitude (power) of the three while being in a positive polarity, this will case an attractive force in this state. Phase A (910a) and C (910c) are inverse but at approximately ½ the magnitude of A. This causes both attractive and repulsive forces based on the magnets that they are in proximity of.

Finally, referring to FIG. 47C, examining the peak of phase C (910c), phase C has the highest magnitude (power) of the three while being in a positive polarity, this will case an attractive force in this state. Phases A (910a) and B (910b) are inverse but at approximately ½ the magnitude of A. This causes both attractive and repulsive forces based on the magnets that they are in proximity of. As these three waves progress, it creates a motion is a very specific direction. However, the start state has to be very specific, if not done properly using the 3 phase driver otherwise could push motion in the wrong direction or result in a stall. This is the reason that servo systems (e.g. 3 phase positioning) is much more expensive to achieve than 2 phase (Step) systems, which are much more determinate on direction, but don't have the efficiency of 3 phase.

A method is provided for controlling a transport carriage 104 in a warehouse facility and includes providing a linear driver conveyor system 100 having an array of guide tracks 102 for supporting and guiding carriages as they move throughout the warehouse facility. The carriage is propelled by a linear drive system 105 having a series of drivers 106 along the guide tracks 102. The drivers 106 are controlled by a warehouse management system. The method includes determining, with the warehouse management system, that the carriage is to be transported from one location in the warehouse facility to another/required location elsewhere in the facility. The warehouse management system activates a first driver 106 that is most proximate and upstream of the carriage 104 to push and/or pull the carriage along the guide track 102 in the direction of the required location. In sequence, the warehouse management system then another one of the drivers 106 that is directly downstream of the first driver to continue pushing or pulling the carriage 104 along the guide track in the direction of the required location. It may be necessary or desired to deactivate the first/upstream driver 106 before activating the second/downstream driver 106.

The method of controlling the carriage 104 includes determining a location of the carriage relative to the first driver 106 with a carriage position sensor 114 and then activating the second driver 106 to continue pushing or pulling the carriage once it has exited the influence of the first driver. The method may also include determining the location of a portion of a magnetic array 108 of a carriage 104 relative to the carriage position sensor 114 and/or relative to one or more drive coils 122, 124 of a driver 106. Determining the location of the carriage relative to the first driver includes detecting the entry of the carriage into proximity with the first driver with a first carriage presence sensor at an upstream side of the driver 106 and/or detecting the exit of the carriage from proximity with the first driver with a second carriage presence sensor at a downstream side of the driver. The method of controlling the movement of the carriage 104 may include microstepping a stepper motor of a driver 106, or in other words driving the stepper motor at less than one full drive step. For example, the microstepping may include driving the stepper motor at any of the following exemplary levels, including at ½ of a drive step, ¼ of a drive step, ⅛ of a drive step, 1/16 of a drive step, 1/32 of a drive step, 1/64 of a drive step, 1/128th of a drive step, and 1/256th of a drive step.

The method may also include determining a presently required capacity of carriages within the warehouse facility with the warehouse management system, and may then include either introducing additional carriages into the linear driver conveyor system 100 or removing carriages from the linear drive conveyor system to meet the presently required capacity within the warehouse facility. Injection or induction of carriages into the system could be performed by pushing a carriage into an injection zone 121. Dynamic injection and removal of carriages 104 may reduce congestion at low volume times and additional carriages may be injected during high demand situations. Given the uniformity and flatness of the surface injection/induction/removal processes could be automated, such as with a carriage buffer connected to the injection zone 121, for example. An operator may drop or place a carriage directly onto the guide track from above. For example, robotic stackers and de-stackers may be utilized to drop and pick carriages off the guide track. This may also be performed with robotic arms.

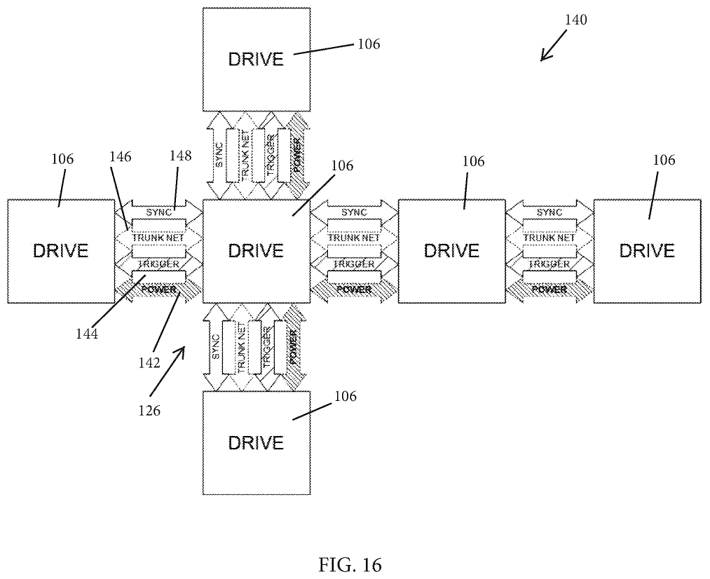

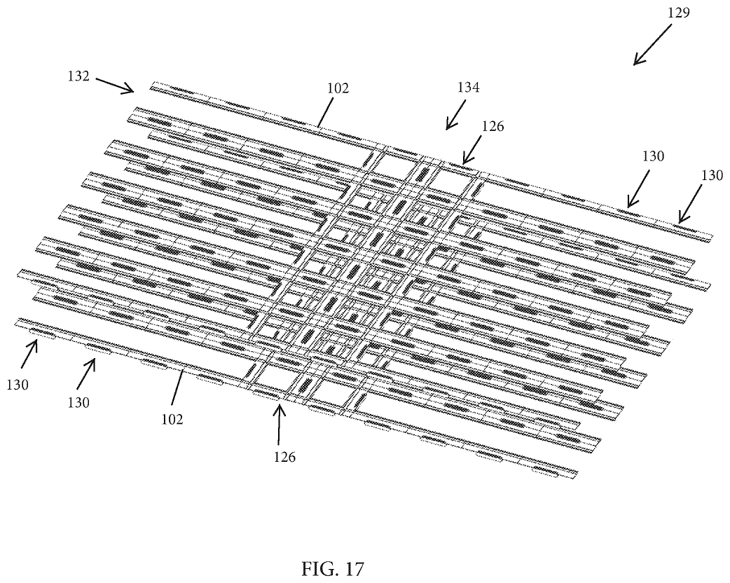

Referring to the exemplary control diagram of FIG. 16, a connectorized interlock is illustrated and depicts a control interface 140 for the system 100. The interface 140 includes controls for power/energization 142, trigger 144 for addressing and syncing interrupts, trunk style network (e.g. CAN or other) 146, and a local node to node SYNC communication 148 for coordination of motion between drivers 106. Power 142 is coupled and passed through each device/driver. Each driver 106 providing its own conditioning and regeneration management. The primary communications network, in the form of the trunk style network 146 provides simplified installation and enables branch routing. In some implementations, the interface 140 may include multiple controllers to provide connectivity to other networks and/or drivers 106 using the same or different protocols via one or more of an Ethernet, Ethernet over multiprotocol Label Switching (MPLS), a high-speed serial interface (HSSI), Local Interconnect Network (LIN), a Peripheral Component Interconnect (PCI), a Smart Network Interface circuitry, among many others. The SYNC 148 is a node to node communications system in which communication is performed between a single point to single point, single point to two or more points, or multiple points. The SYNC 148 for each driver 106 communicates its present state to its immediate neighbors (i.e. upstream and downstream drivers 106). Trigger 144 is provided in the form of a pair of wires that provide a self-addressing method for the trunk network 146 while also providing a basic notification to the neighbor nodes.

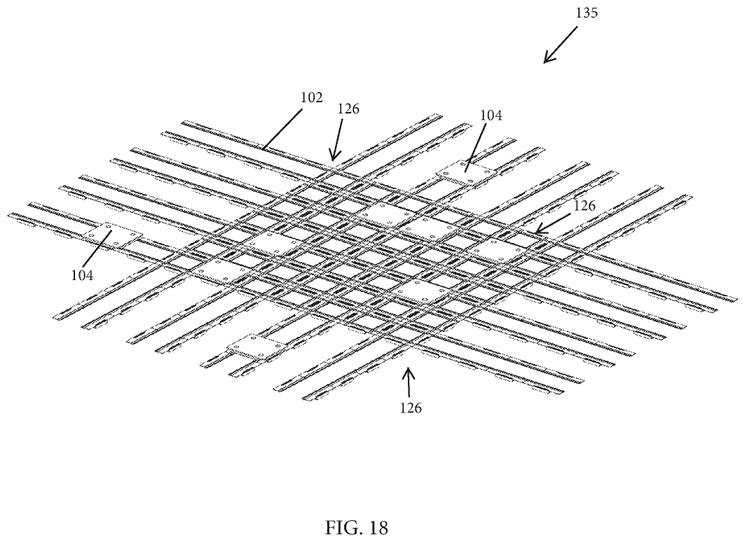

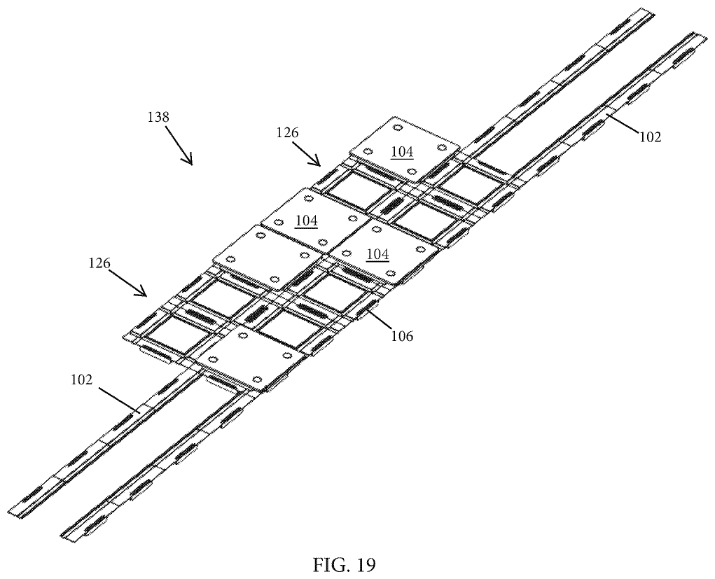

Examples of use cases are described below, with some examples illustrated in FIGS. 17-22. An array of guide tracks 102 and transfers 126 are depicted in FIG. 17 to provide an automated storage and retrieval system (ASRS) or high density storage system 129. Each transfer zone 126 and each storage location 130 having its own drive(s). In this configuration, multiple inbound and outbound orders and/or inventory items can be accessed or stored at the same time. Multiple inbound and outbound routes are provided by the array of rails 102 and transfers 126, reducing potential bottlenecks or blockages, which may increase throughput. As an example, a carriage that carries an item need not transfer the item to another form of conveyance (e.g. from shuttle to buffer to lift to conveyer) to move the item from the ASRS 129 to its required location anywhere in the facility. Blocking items/carriages can be shifted out of the way from side aisles 132 and into the main aisle 134. That blocking item can be returned to its original storage location 130 without needing a buffer location to store blocking items. In other words, items always remain on their respective carriages during transport in the system, and thus moving blocking items only requires moving the respective carriage out of the way, and no vehicle transfers are required. Inbounding, receiving, and shipping may be made more efficient utilizing a large array 135 (FIG. 18) of rails 102 and transfers 126 (FIG. 18). An array 138 of guide tracks 102 and transfers 126 may be configured for palletizing systems, such as an automated mixed case palletizing system, to enable randomized input of goods to many different pallets under construction and also enabling sequenced outputs of completed pallets. Use of an ASRS 129 configuration and/or a palletizing array 138 (FIG. 19) facilitates fast order retrieval. In this manner, the warehouse control system may prioritize organization of orders such that “ready” orders (e.g. ready to ship, ready to pack, ready for customer pickup, etc.) could be pre-positioned or prioritized in the array, while on demand orders (i.e. not currently ready orders) can be maintained at a “normal” rate or priority level. For example, the system can be controlled to efficiently move everything in an order to the front of the system so that it is pre-consolidated for quick picking when it is ready to be picked. This may be particularly beneficial during off peak times, where the system resources can be dedicated to organization and optimization, as opposed to fulfilment. Optionally, the array may be dynamic and able to dynamically organize itself to make sure required items are front and center at all times.

Thus, the linear drive conveyor provides a material handling and transport system having minimal moving or dynamic components. The conveyor includes right angle transfers without any lifts or dynamic components, greatly simplifying the system as compared to commonly available right angle transfers and thus reducing resource requirements and costs. The conveyor includes carriages that are supported on guide tracks and driven by linear drivers. Goods supported on the carriages may remain on the carriage during transport and storage within the system.

Changes and modifications in the specifically described embodiments can be carried out without departing from the principles of the present invention, which is intended to be limited only by the scope of the appended claims, as interpreted according to the principles of patent law including the doctrine of equivalents.

1. A conveyor system for transporting goods within a warehouse facility, the conveyor system comprising:
a plurality of guide tracks disposed in the warehouse facility;
a carriage supported on and moveable along said guide tracks and configured to support goods for transport within the warehouse facility;
a drive system for propelling said carriage along said guide tracks; and
said drive system comprising a driver coupled at a portion of said guide track and configured to remotely push and/or pull said carriage without contacting said carriage to propel said carriage along said guide tracks relative to said driver, and said driver in communication with and responsive to said warehouse management system.

2. The conveyor system of claim 1, wherein said carriage comprises a plurality of roller supports configured to support said carriage at a support surface of said guide tracks.

3. The conveyor system of claim 2, wherein each of said roller supports comprises a ball transfer bearing.

4. The conveyor system of claim 2, wherein each of said guide tracks comprises a pair of spaced apart side rails, each of said side rails comprising a channel formed therein and configured to receive a portion of one of said roller supports to at least partially retain said roller support in a desired position along said side rail.

5. The conveyor system of claim 1, wherein said carriage comprises a magnetic array and said driver comprises a linear induction motor system having a drive coil coupled to said guide track and configured to magnetically push and/or pull said magnetic array of said carriage in order to propel said carriage along said guide tracks.

6. The conveyor system of claim 5, wherein said linear induction motor comprises a 2-phase stepper motor or a 3-phase motor.

7. The conveyor system of claim 5, further comprising a warehouse management system adapted for controlling said drive system to transport goods on said carriage within the warehouse facility and a carriage presence sensor coupled at least one of said guide tracks and said carriage, and said carriage presence sensor configured to communicate a location of said carriage relative to said driver to said warehouse management system.

8. The conveyor system of claim 7, further comprising a carriage presence sensor coupled at least one of said guide tracks and said carriage, and said carriage presence sensor configured to communicate a location of said carriage relative to said driver to said warehouse management system, and optionally wherein said presence sensor is selected from a group consisting of Hall effect sensor, magnetic proximity sensor, MEMS sensor, optical sensor, mechanical sensor, and integrated sensor.

9. The conveyor system of claim 8, comprising a plurality of said drivers disposed along said guide tracks and a plurality of said carriage presence sensors, wherein at least one of said plurality of said carriage sensors is provided proximate each one of said drivers.

10. The conveyor system of claim 9, wherein a pair of said carriage presence sensors are provided at each of said drivers, wherein a first one of said pair of carriage presence sensors is provided at an upstream side of a particular one of said drivers to detect entry of said carriage into proximity with said particular driver and a second one of said pair of carriage presence sensors is provided at a downstream side of said particular driver to detect exit of said carriage from proximity with said particular driver. Page . . .

11. The conveyor system of claim 1, wherein said array of guide tracks comprises one or more intersections of guide tracks, said intersections form a transfer location for carriages to transfer from one of said guide tracks to another of said guide tracks.

12. The conveyor system of claim 1, further comprising an RFID reader system disposed throughout the warehouse facility and in communication with said warehouse control system, and an RFID tag coupled to said carriage, wherein said warehouse control system is operable to track a position said carriage relative to said driver as a function of said RFID reader system reading said RFID tag of said carriage.

13. A method of controlling a transport carriage in a warehouse facility, said method comprising:
providing a conveyor system having an array of guide tracks configured to support and guide a transport carriage as it moves throughout the warehouse facility, wherein said carriage is propelled by a drive system having a series of drivers disposed along said guide track;
determining that said carriage is to be transported from one location in the warehouse facility to a required location;
activating a first one of said series of drivers that is proximate said carriage to push or pull said carriage along said guide track in said direction of said required location without contacting said carriage; and
activating a second one of said series of drivers downstream of said first driver to continue pushing or pulling said carriage along said guide track in said direction of said required location.

14. The method of claim 13, further comprising deactivating said first driver before activating said second driver.

15. The method of claim 13, further comprising determining a location of said carriage relative to said first driver with a carriage position sensor and activating said second driver to continue pushing or pulling said carriage once it has exited the influence of said first driver.

16. The method of claim 15, wherein said determining the location of said carriage relative to said first driver comprises detecting the entry of said carriage into proximity with said first driver with a first carriage presence sensor at an upstream side of said driver and/or detecting the exit of said carriage from proximity with said first driver with a second carriage presence sensor at a downstream side of said driver.

17. The method of claim 15, wherein each of said series of drivers comprises a 2-phase stepper motor and said activating of any of said series of drivers comprises microstepping said 2-phase stepper motor.

18. The method of claim 17, wherein said microstepping comprises driving said stepper motor at less than one full drive step.

19. The method of claim 17, wherein said microstepping comprises driving said stepper motor at least one chosen from ½ of a drive step, ¼ of a drive step, ⅛ of a drive step, 1/16 of a drive step, 1/32 of a drive step, 1/64 of a drive step, 1/128th of a drive step, and 1/256^{th} of a drive step.

20. The method of claim 13, wherein said conveyor system comprises a plurality of said carriages and said method further comprising determining a presently required capacity of carriages within the warehouse facility with a warehouse management system, and either chosen from introducing additional carriages into said conveyor system and removing carriages from said conveyor system to meet the presently required capacity.

21. A conveyor system adapted to control processing operations comprising:
a trunk network;
a SYNC network for coordination of motion between a first driver and a second driver; and
a trigger configured to address and sync one or more interrupts of said trunk network;
wherein said SYNC network causes one of said first driver or said second driver to communicate a present state of the said first or second driver.
